(19) United States
(12) Patent Application Publication
(10) Pub. No.: US 2019/0253967 A1
(43) Pub. Date: Aug. 15, 2019

(54) MANAGING TARGET WAKE TIME SCHEDULING USING CONGESTION METRICS

(71) Applicant: QUALCOMM Incorporated, San Diego, CA (US)

(72) Inventors: Yongchun XIAO, San Jose, CA (US); Sandip HOMCHAUDHURI, San Jose, CA (US); Pradeep Kumar YENGANTI, Cupertino, CA (US); Sanoop KOTTONTAVIDA, San Jose, CA (US); James Simon CHO, Mountain View, CA (US); Srinivas KATAR, Fremont, CA (US); Shuibing DAI, Cupertino, CA (US)

(21) Appl. No.: 15/896,799

(22) Filed: Feb. 14, 2018

(51) Int. Cl. H04W 52/02; H04W 28/02

(52) U.S. Cl. CPC H04W 52/0216; H04W 28/0284; H04W 76/28; H04W 52/0219; H04W 28/0289

(57) ABSTRACT

Various aspects provide a wireless station (STA) to implement congestion sensitive target wake time (TWT) communications scheduling and enable the STA to determine whether to engage in communications between TWT service periods. A method described includes identifying a congestion metric, determining whether the congestion metric meets a congestion threshold, and transmitting a request to establish TWT communications in response to determining that the congestion metric meets the congestion threshold. Another method described includes terminating a scheduled service period of a TWT communications, receiving an indication that a threshold number of frames is available for transmission to an STA from an access point (AP) or an indication that one or more frames are present in a transmission queue at the STA, and transmitting, by the STA to the AP an indication that a communications link is to remain active between the terminated scheduled service period and a subsequent scheduled service period.

### BACKGROUND

The present disclosure relates generally to wireless communications, and specifically to techniques for scheduling, modifying, and removing target wake time communications scheduling between a wireless station (STA) and an access point (AP) that may provide improved signal quality, data rate, reliability, quality of service (QoS) to the STA.

The deployment of wireless local area networks (WLANs) in the home, the office, and various public facilities is commonplace today. Such networks typically employ a wireless AP that connects a number of wireless STAs in a specific locality (e.g., home, office, public facility, etc.) to another network, such as the Internet or the like. In a dense WLAN deployment, a number of STAs may be in constant communication with each AP. An STA, in a conventional WLAN architecture, may transmit and receive frames at will, as needed, or according to a schedule set up by the AP. Such loose communications scheduling may present problems when network usage is high and congestion caused by the high network usage may result in communications collisions, affecting both throughput and power usage. In such cases, for example, an AP may struggle to receive, process, and transmit a high volume of packets from a myriad of sources, which may result in frames or packets being dropped or misinterpreted and a degraded quality of service (QoS) for a user.

To alleviate the problem of dense deployments, WLANs implementing IEEE 802.11ah and newer standards (e.g., IEEE 802.11ax) may make use of techniques for Target Wake Time (TWT) communications scheduling that are supported in those standards. TWT allows an AP to define a specific time or time intervals for each connected STA to wake in order to access or exchange information with the AP. For example, the AP may stipulate a communications interval duration for each connected STA. For example, an AP centralizes the transmission/reception operations for a groups of STAs to minimize collisions in a dense deployment, thereby reducing contention and saving power. The use of TWT may be negotiated between an AP and each individual STA. During the set up of a schedule for TWT communications set up, an STA and an AP exchange information that includes an expected activity duration to allow the AP to control the amount of overlap among competing STAs and schedule the various STAs in specific communication slots. The scheduling of TWT communications may be used to reduce network energy consumption, as STAs that use it can reduce power consumption by entering into a sleep (or similar) state until their corresponding TWT slot is available.

However, conventional scheduling of TWT communications may not account for the need to meet power, throughput, and latency requirements in dense environments. In these conditions, conventional scheduling of TWT communications may not address how to implement voice over Internet Protocol (VoIP), handle continuous changes in the amount of traffic, handle the need to send or receive additional information when an allocated period is terminated or outside an allocated time period, and/or handle off-channel operations. As such, techniques for implementing the scheduling and operation of TWT communications that address some of the issues that arise during dense deployments are desirable.

### SUMMARY

Aspects of the present disclosure address the above-identified problems by implementing techniques that allow the scheduling and operation of TWT communications in a manner that is responsive to network congestion that may occur in dense WLAN deployments. These aspects may include the use of smart or specific triggers for TWT operations and the tuning based on congestion, throughput, and/or latency constraints or requirements. These aspects further enable STAs and APs to determine how best to proceed when there are scheduled TWT communications, or when there is a switch or tune away to another channel. By identifying different types of network congestion and adjusting, setting up, or tearing down the scheduling of TWT communications based on a current degree of network congestion, the STAs and/or APs can avoid implementing certain TWT parameters that may be unsuitable to enable appropriate operations under current network conditions. Further, the STAs may determine whether it is necessary for the STA to wake or request a network resource to transmit or receive between scheduled periods of operations, thereby reducing the likelihood of needless power usage in state switching.

In an aspect, a method for scheduling communications between an STA and an AP is disclosed. In some aspects, the method may include identifying a congestion metric, determining whether the congestion metric meets a congestion threshold, and transmitting, by a transceiver of the STA, a request to establish TWT communications in response to determining that the congestion metric meets the congestion threshold.

In another aspect, an apparatus for wireless communications with an AP is disclosed. The apparatus may include a transceiver, a memory, and a processor coupled to the transceiver and the memory. The processor is configured to identify a congestion metric, determine whether the congestion metric meets a congestion threshold, and transmit, by the transceiver, a request to establish TWT communications in response to determining that the congestion metric meets the congestion threshold. In an aspect, the memory may include instructions executable by the processor such that the processor by executing the instructions is configured to performed the functions described above.

In another aspect, an apparatus for wireless communications with an AP is disclosed. The apparatus may include means for identifying a congestion metric, means for determining whether the congestion metric meets a congestion threshold, and means for transmitting a request to establish TWT communications in response to determining that the congestion metric meets the congestion threshold.

In yet another aspect, a computer-readable medium storing computer executable code for wireless communications between an STA and an AP is disclosed. The computer-readable medium may include code for identifying a congestion metric, code for determining whether the congestion metric meets a congestion threshold, and code for transmitting a request to establish TWT communications in response to determining that the congestion metric meets the congestion threshold.

In an aspect, a method for scheduling communications between an STA an AP is disclosed. In some aspects, the method may include terminating a scheduled service period (SP) of a TWT communications, receiving, by the STA, at least one of an indication that a threshold number of frames is available for transmission to the STA from the AP and an indication that one or more frames are present in a transmission queue at the STA, and transmitting, by a transceiver of the STA, to the AP, an indication that a communications link is to remain active between the terminated scheduled service period and a subsequent or second scheduled service period.

In another aspect, an apparatus for wireless communications with an AP is disclosed. The apparatus may include a transceiver, a memory, and a processor coupled to the transceiver and the memory. The processor may be configured to terminate a scheduled service period of a TWT communications, receive at least one of an indication that a threshold number of frames is available for transmission to the apparatus from the AP and an indication that one or more frames are present in a transmission queue at the apparatus, and transmit to the AP, an indication that a communications link is to remain active between the terminated scheduled service period and a subsequent or second scheduled service period.

In another aspect, an apparatus for wireless communications to an AP is disclosed. The apparatus may include means for terminating a scheduled service period of a TWT communications, means for receiving at least one of an indications that a threshold number of frames is available for transmission to the apparatus from the AP and an indication that one or more frames are present in a transmission queue at the apparatus, and means for transmitting to the AP, an indication that a communications link is to remain active between the terminated scheduled service period and a subsequent or second scheduled service period.

In yet another aspect, a computer-readable medium storing computer executable code for wireless communications between an STA and an AP is disclosed. The computer-readable medium may include code terminating a scheduled service period of a TWT communications, code receiving at least one of an indication that a threshold number of frames is available for transmission to the STA from the AP and an indication that one or more frames are present in a transmission queue at the STA, and code for transmitting to the AP, an indication that a communications link is to remain active between the terminated scheduled service period and a subsequent or second scheduled service period.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a diagram illustrating an example of a wireless local area network (WLAN) deployment in accordance with various aspects.

FIG. 2 is a diagram illustrating a conventional configuration or scheduling of TWT communications in accordance with various aspects.

FIG. 3 is a timeline diagram for conventional individual TWT communications between an AP and one or more STAs that are solicited or unsolicited in accordance with various aspects.

FIG. 4 is a timeline diagram for baseline aspects of TWT communications flow of events for an individual TWT set up in accordance with various aspects.

FIG. 5 is a timeline diagram illustrating baseline aspects of a start and a termination of a TWT service period.

FIG. 6 is a flow diagram illustrating an example method for implementing TWT communications in IEEE 802.11ax for voice over Internet Protocol (VoIP) calls in accordance with various aspects of the present disclosure.

FIG. 7 is a diagram illustrating the identification of congestion metrics by an STA in accordance with various aspects of the present disclosure.

FIG. 8 is a timeline diagram illustrating an example of transitioning between power management settings, PM 0 and PM 1, in accordance with various aspects of the present disclosure.

FIG. 9 is a timeline diagram illustrating an example of service period termination while there are pending frames for transmission or reception in accordance with various aspects of the present disclosure.

FIG. 10 is a timeline diagram illustrating an example of TWT communications implemented for a VoIP call in accordance with various aspects of the present disclosure.

FIG. 11 is a timeline diagram illustrating different examples of using an uplink (UL) ping when transmission frames are queued from an upper layer in accordance with various aspects of the present disclosure.

FIG. 12 is a timeline diagram illustrating different examples of using a downlink (DL) ping when frames are buffered at an AP in accordance with various aspects of the present disclosure.

FIG. 13 is a timeline diagram illustrating examples of modifications to TWT communications based on changes in throughput in accordance with various aspects of the present disclosure.

FIG. 14 is a diagram illustrating examples of off-channel operations in TWT communications in accordance with various aspects of the present disclosure.

FIG. 15 is a flow diagram illustrating techniques for TWT communications based on congestion metrics in accordance with various aspects of the present disclosure.

FIG. 16 is a flow diagram illustrating a method for adjusting a duty cycle of TWT communications in accordance with various aspects of the present disclosure.

FIG. 17 is a flow diagram of a method for scheduling TWT communications in accordance with various aspects of the present disclosure.

FIG. 18 is a schematic diagram of a device including an aspect of an STA that may implement various aspects of the present disclosure.

FIG. 19 is a schematic diagram of a device including an aspect of an AP that may implement various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Various aspects of the present disclosure allow a wireless station (STA) to set up, adjust, and/or tear down scheduling of target wake time (TWT) communications that addresses network congestion in dense deployments and also enable the STA to determine whether to engage in communications between TWT service periods. As described herein, TWT or TWT communications refer to specific times or sets of times that are scheduled or assigned for individual STAs to wake in order to exchange frames (e.g., a bidirectional exchange) with an AP or with another STA. TWT or TWT communications allow for the centralization of transmissions and receptions for a group of STAs minimizing the collisions that may occur in, for example, IEEE 802.11ax, thereby reducing the amount of power that may be wasted in a densely populated medium. These aspects may include techniques for identifying or obtaining a congestion metric, determining whether the congestion metric meets a congestion threshold, and transmitting, by a transceiver of the STA, a request to establish TWT communications in response to determining that the congestion metric meets the congestion threshold. In another aspect, these aspects may include techniques for terminating a scheduled service period of a TWT communications, receiving, by an STA, at least one of an indication that a threshold number of frames is available for transmission to the STA from an AP and an indication that one or more frames are present in a transmission queue at the STA, and transmitting, by a transceiver of the STA, to the AP, an indication that a communications link is to remain active between the terminated scheduled service period and a subsequent or second scheduled service period. In some aspects, these techniques may be implemented as part of the initiation of a voice over Internet Protocol (VoIP) call. The aspects may include adjusting or terminating TWT communications based, at least in part on whether a network congestion satisfies or exceeds congestion thresholds or whether the network congestion has increased. Aspects may enable an STA to determine how far away a subsequent TWT service period is from a current time and determine whether to engage in communications before the next TWT service period or place a network resource in a sleep state.

The various aspects described herein may solve at least the problem of power consumption that may result from collisions in, for example, IEEE 802.11ax dense deployments, Moreover, the various aspects described herein may also address the additional problems that arise in dense deployments such as the need to meet power, throughput, and latency requirements, to implement VoIP, handle continuous changes in the amount of traffic, handle the need to send or receive additional information when an allocated period is terminated or outside an allocated time period, and/or handle off-channel operations. As used herein, the terms “service period”, “TWT service period” and “TWT SP” commonly refer to a period of time during which TWT STA wakes up to transmit and receive frames. Within a TWT service period, the STA and/or AP may perform a short interframe space (SIFS)-burst, Orthogonal frequency-division multiple access (OFDMA) communications, or multi-user, multiple-input, multiple-output (MU-MIMO) communications. Outside of a TWT service period, the STA may place one or more resources (e.g., portions of a transceiver) in a sleep state.

As used herein, the terms “TWT flow ID”, “TWT flow identifier”, or “Flow ID” may commonly refer to identifiers of a TWT operation. For example, for an individual TWT, the Flow ID may be used to identify a TWT agreement between an STA and an AP. In another example, for a broadcast TWT, the Flow ID may be used to specify frame types that can be exchanged within a service period or SP.

As used herein, the term “TWT parameters” may refer to various parameters associated with TWT operations and may include: a Target Wake Time start (Tₛₜₐᵣₜ), which is an offset after which a first TWT service period will start; a nominal TWT wake duration (T_{dur}), which is a nominal TWT slot duration; a TWT wake interval (Tᵢₙₜᵥₗ), which is an interval between two successive TWT service periods; and service period or SP start time, which may be defined by the following sequence:

T1=Tₛₜₐᵣₜ, T2=T1+T_{dur}+Tᵢₙₜᵥₗ, T3=T2+T_{dur}+Tᵢₙₜᵥₗ, . . .

TWT parameters may be transmitted in a set-up frame and may include one or more of the above listed parameters as well as any additional TWT control parameters deemed necessary to implement the present disclosure.

Various aspects of the present disclosure may be particularly well suited to performing individual TWT communications scheduling. In individual TWT communications, an STA may set up with the AP individually (via unicast), where the set up may be identified in part by a 3-tuple of transmitter address (TA), receiver address (RA), and Flow ID In broadcast TWT communications, however, an AP broadcasts TWT service periods in beacons for all confirming STAs. In this case, the set up may be identified in part by a 2-tuple of AP and broadcast TWT ID.

Various concepts will now be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

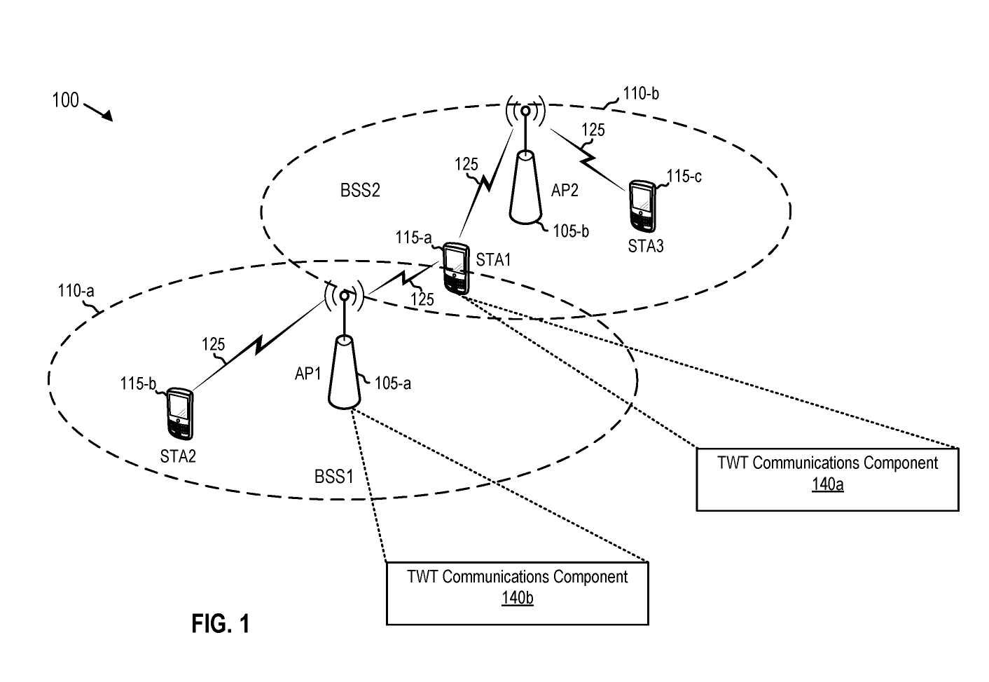

FIG. 1 shows a diagram 100 illustrating an example of a wireless local area network (WLAN) deployment in connection with various techniques described herein. Although limited, the WLAN deployment in FIG. 1 may be representative of a small portion of a dense WLAN deployment. The WLAN may include one or more access points (APs) and one or more mobile or wireless stations (STAs) associated with a respective AP. In this example, there are two APs deployed: AP1 105-a in basic service set 1 (BSS1) and AP2 105-b in BSS2, which may be referred to as an OBSS. AP1 105-a is shown as having at least two associated STAs (STA1 115-a and STA2 115-b) and coverage area 110-a, while AP2 105-b is shown having at least two associated STAs (STA1 115-a and STA3 115-c) and coverage area 110-b. The STAs and AP associated with a particular BSS may be referred to as members of that BSS. In the example of FIG. 1, the coverage area of AP1 105-a may overlap part of the coverage area of AP2 105-b such that STA1 115-a may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling). Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames, packets, or messages through a direct communications channel. It should be noted that the wireless communication system, in some examples, may not have a central AP (e.g., AP1 105-a or AP2 105-b), but rather may function as a peer-to-peer network between the STAs. Accordingly, the functions of an AP 105 described herein may alternatively be performed by one or more of the STAs 115.

Wireless networks with dense deployments, for example, deployments in which larger numbers of STAs try to access and/or maintain communications links (e.g., communications link 125) with an AP, may experience high levels of congestion as many STAs may try to access the medium at the same time. Collisions caused by congested environments may result in, among other things, large amounts of wasted power by STAs as they continue to try to access the medium. The techniques describes in this disclosure may be used to reduce contentions in a densely populated medium to save power by taking into consideration congestion, throughput, and/or latency constraints.

Accordingly, features of the present disclosure enable an STA (e.g. STA1 115-a, STA2 115-b, STA3 115-c) to set up, modify, or tear down TWT communications based on current network congestion, throughput, and latency constraints. Moreover, an STA may consider changes in TWT parameters to accommodate continuous changes in traffic amount. Additionally, an STA may be configured to handle situations in which a TWT service period is terminated but there may be more transmissions and/or receptions pending, situations in which transmission of frames/packets queued from an upper layer or an AP indicates buffered frames/packets while outside a TWT service period, and situations in which the TWT service period is in progress but the WLAN transceiver has switched to a channel other than the home channel.

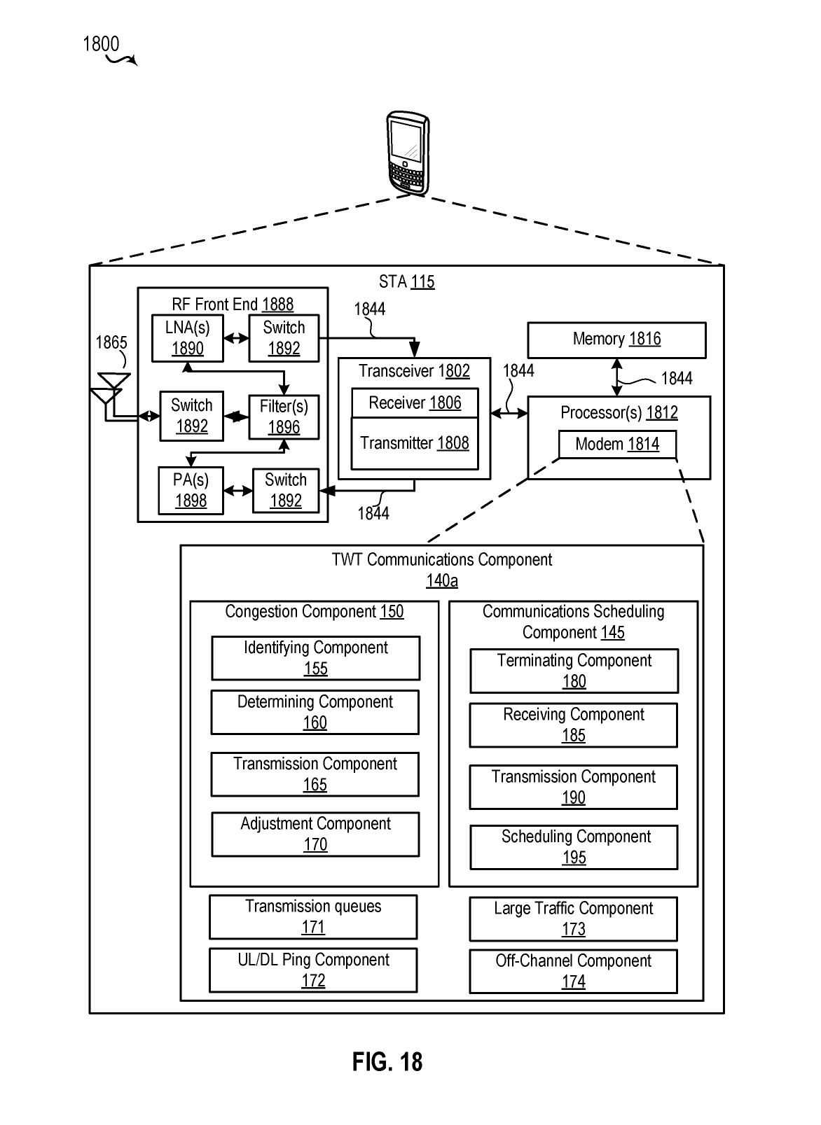

In various aspects, an STA (e.g., STA1 115-a) may include software applications and supporting hardware to implement a TWT communications component 140a having subcomponents to assist in performing aspects described herein related to at least setting up, modifying, and/or tearing down TWT communications (e.g., scheduling for TWT communications) with a corresponding AP (e.g., AP1 105-a). Additional details regarding the TWT communications component 140a are provided below in connection with FIG. 18.

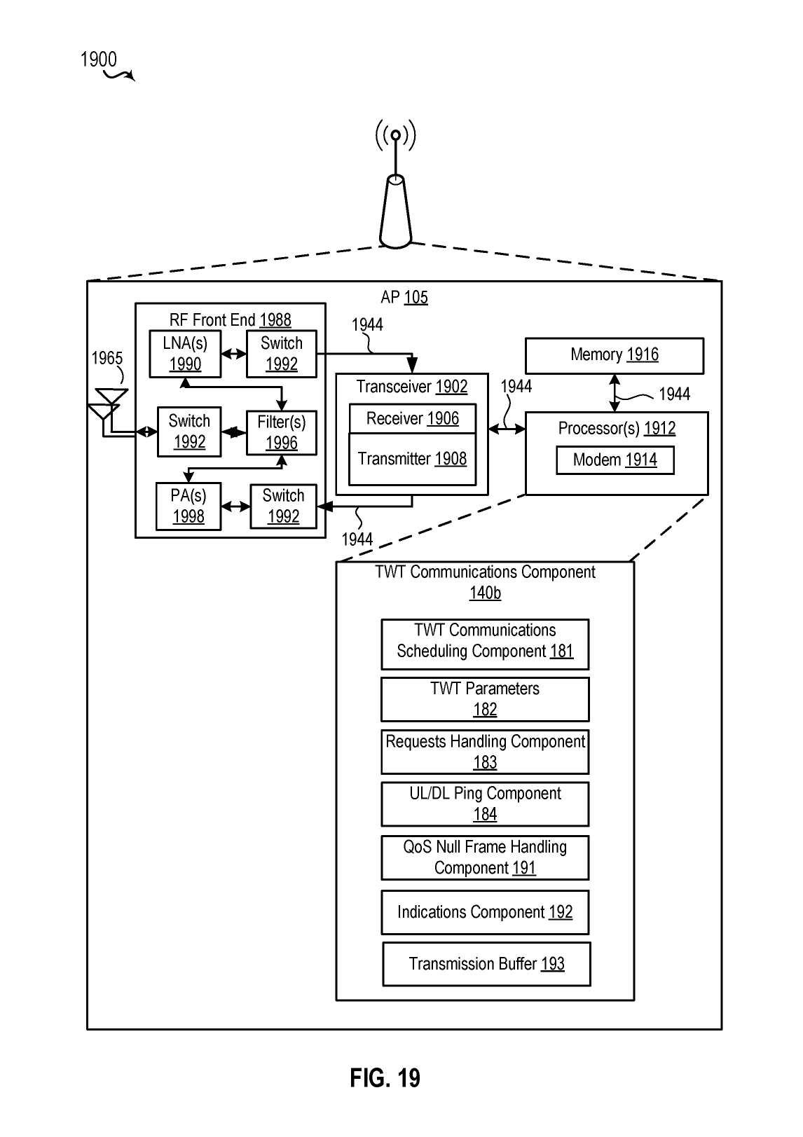

In other aspects, an AP (e.g., AP1 105-a) may include software applications and supporting hardware to implement a TWT communications component 140b having subcomponents to assist in performing aspects described herein to enable an STA to at least set up, modify, and/or tear down TWT communications. Additional details regarding the TWT communications component 140b are provided below in connection with FIG. 19.

In connection with FIGS. 18 and 19 below describing the TWT communications components 140a and 140b, various aspects may allow their subcomponents to engage and support each other, without being limited to servicing specific neighbor subcomponents. While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

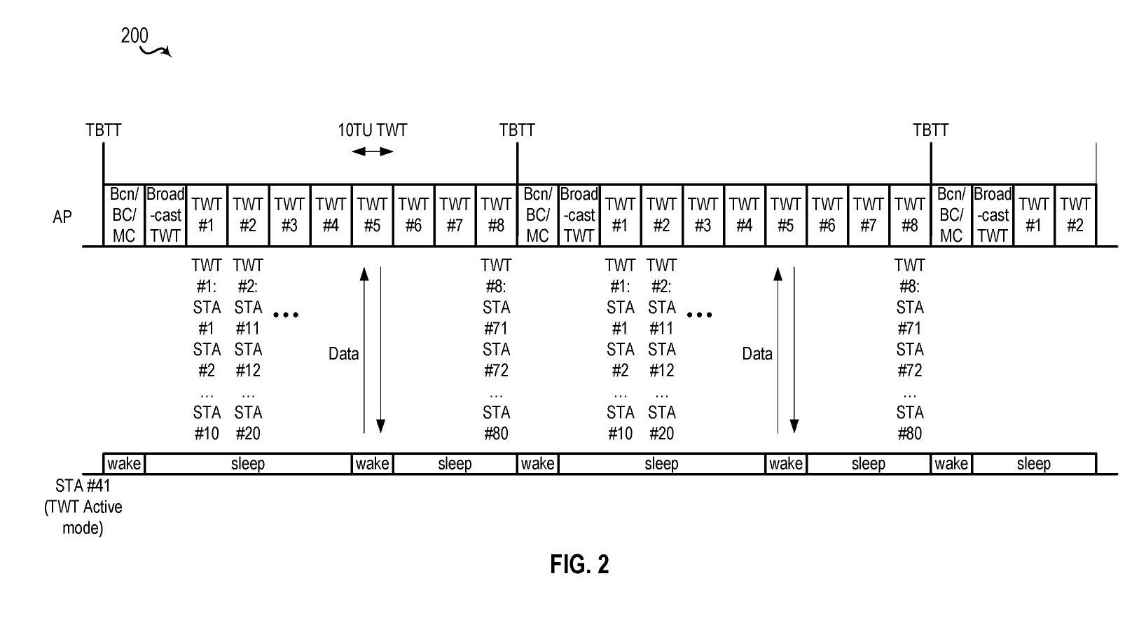

FIGS. 2-5 described below provide a baseline of TWT operations from which the various techniques presented in this disclosure are based.

FIG. 2 shows a diagram 200 associated with baseline aspects of scheduling TWT communications between an AP and a multiple STAs. The STAs in the diagram 200 may correspond to the STAs 115 described in FIG. 1; similarly, the AP in the diagram 200 may correspond to the APs 105 in FIG. 1.

As noted above, the scheduling of TWT communications may provide a specific time or set of times for individual STAs (e.g., STAs 115) to wake in order to exchange frames or packets with other STAs or an AP (e.g., an AP 105). In the illustrated example in FIG. 2, there is shown an interval identified as a target beacon transmission time (TBTT) that includes 10 time units (TUs) or slots. A first slot after the TBTT is associated with the transmission of a beacon (bcn), a second slot is associated with a TWT broadcast agreement, and following eight (8) TWT slots (TWT #1, . . . , TWT #8) associated with different allocations of times for different STAs, where each of these eight TWT slots can handle up to 10 STAs. That is, slots 3-8 deal with individual TWT (I-TWT) agreements, where each slot has 10 I-TWT agreements, and where each I-TWT agreement has only one STA and one AP. For example, the slot TWT #1 is associated with STA #1 (e.g., I-TWT agreement between STA#1 and the AP), . . . , STA #10 (e.g., I-TWT agreement between STA#10 and the AP), and the slot TWT #2 is associated with STA #11 (e.g., I-TWT agreement between STA#11 and the AP), . . . , STA #20 (e.g., I-TWT agreement between STA#20 and the AP). Each STA may awake only during its corresponding or specific TWT slot to perform bidirectional data traffic with an AP or with another STA.

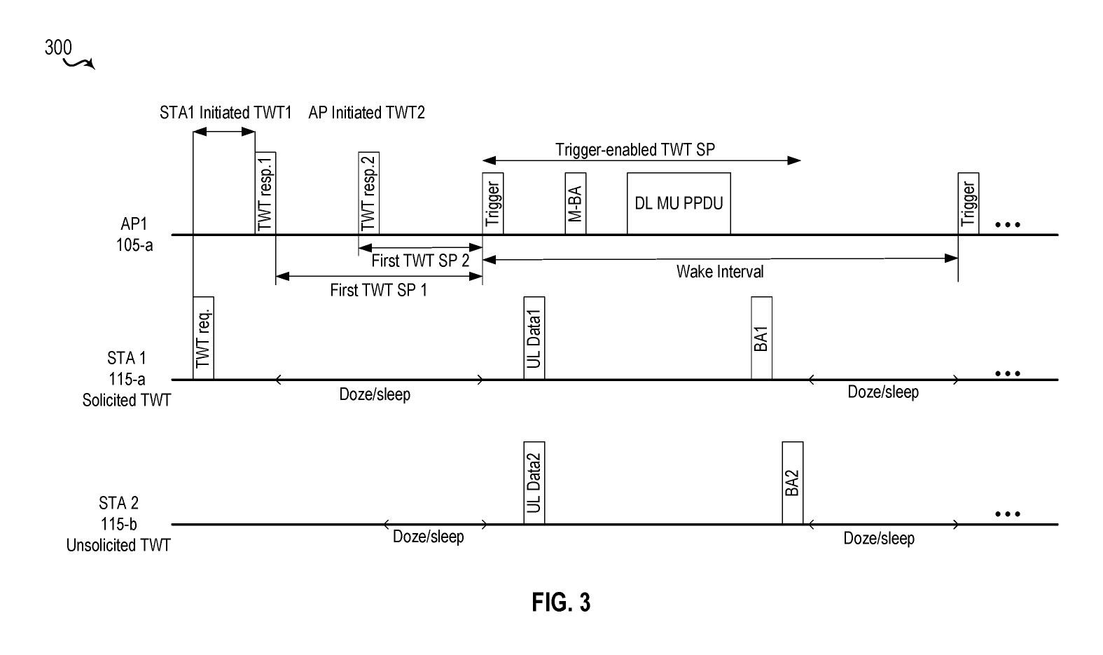

The scheduling of TWT communications described in the diagram 200 is based on a “individual” type TWT (see e.g., FIG. 3) implemented for the different STAs in a group of STAs where each STA establishes a TWT scheduling agreement with the AP. These individual TWT scheduling agreements may have overlapping service periods or wake durations. That is, two or more individual agreements may align such that they may have the same wakeup timeline as illustrated in FIG. 2. For example, during the slot TWT #1 (also referred to as TWT service period or TWT SP), STA #1, . . . , STA #10 may be scheduled to wake and may therefore transmit/receive data with the AP during the specific time interval of the slot TWT #1. During the slot TWT #2, STA #11, , STA #20 may be scheduled to wake and may therefore transmit (Tx)/receive (Rx) data with the AP during the specific time interval of the slot TWT #2. In the example described in the diagram 200, an STA #41 is associated with the slot TWT #5 and wakes when this TWT slot occurs in order to perform a bidirectional data exchange with the AP.

The AP can coordinate or centralize control of the TWT slots and the STAs associated with the TWT slots in accordance with the interval between TBTTs and therefore may manage which STAs perform transmission/reception of data at any given point in time. Because collisions in a congested environment can lead to large amount of wasted power, by coordinating the times at which the STA wake it may be possible to reduce the contention in a densely populated medium and save power since the STAs are asleep until their respective TWT slot occurs.

The TWT communications scheme described in the diagram 200, however, may not take into account the type of congestion, throughput, and/or latency constraints that may be required in dense deployments based on, for example, IEEE 802.11-ax.

FIG. 3 shows a timeline diagram 300 illustrating baseline aspects for establishing individual TWT communications between an AP and one or more individual STAs that are solicited or unsolicited. In this example, the AP is AP1 105-a and the STAs are STA1 115-a and STA2 115-b, which as shown in FIG. 1 form a BSS1.

Solicited TWT communications may occur when an STA initiates or sets up TWT communications with an AP. For example, the STA1 115-a may suggest or request some TWT parameters, which the AP1 105-a may accept, reject, or adjust/change. The STA1 115-a may therefore transmit a request (TWT req.) to the AP1 105-a, which in turn may send a response (TWT resp. 1) to the STA1 115-a as part of a TWT 1 initiated by the STA1 115-a. After establishing the TWT communications (e.g., TWT 1), the STA1 115-a may enter a doze/sleep state until the designated wake interval or slot in connection with a first TWT service period (SP) 1.

Conversely an STA may be subject to scheduling of unsolicited TWT communications by an AP. Unsolicited TWT communications may occur when the AP sends unsolicited TWT frames or packets to the STA, which the STA has to accept. If the STA is unable to sustain the unsolicited TWT communications, the STA may later reject the TWT communications. For example, in the diagram 300, the AP1 105-a may send an indication (TWT resp. 2) to the STA2 115-b as part of a TWT2 initiated by the AP1 105-a. After establishing the TWT communications (e.g., TWT 2), the STA2 115-b may enter a doze/sleep state until the designated wake interval or slot in connection with a first TWT service period (SP) 2.

In some aspects, the AP 105 may employed unsolicited TWT communications scheduling to join STAs into a broadcast TWT group. For example, STA 2 may be joined to a TWT group with STA 1 using unsolicited communications scheduling, so that both STA 1 and STA 2 wake and transmit/receive during the same time periods.

After the first TWT SP1 and the first TWT SP2, a trigger is generated by the AP1 105-a that initiates a trigger-enabled TWT SP and wake interval. During the trigger-enabled TWT SP, the STA1 115-a may transmit or send data to the AP1 105-a (e.g., UL Data 1) and the STA2 115-b may transmit or send data to the AP1 105-a (e.g., UL Data 2). The transmission of UL Data 1 and UL Data 2 may occur at the same time. In response, the AP1 105-a may transmit or send a multiple block acknowledgment (M-BA) followed by downlink, multi-user PLCP protocol data unit (DL MU-PPDU). The STA1 115-a may respond with a block acknowledgment (BA1) while the STA2 115-b may subsequently respond with a block acknowledgement (BA2). Also shown in the diagram 300 is a next trigger after the end of the wake interval.

As illustrated in the diagram 300, the AP1 105-a may bucket multiple individual TWT communications so that different STAs exchange data in the same time slots. However, the TWT communications for each STA may need to be set up individually, whether it is done in a solicited fashion by the STA or in an unsolicited fashion by the AP.

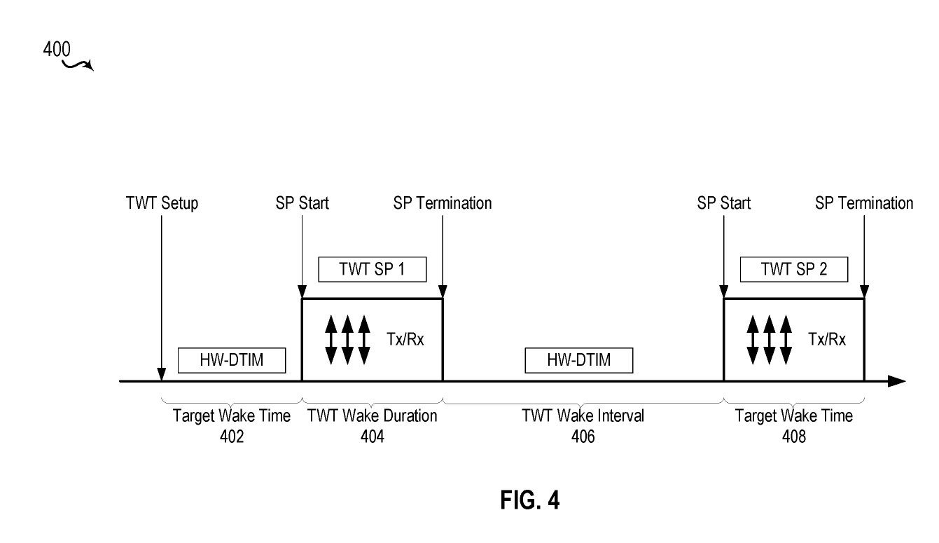

FIG. 4 shows a timeline diagram 400 illustrating baseline aspects of TWT communications flow of events for an individual TWT set up.

During a TWT communications set up, such as the one shown in the diagram 400, an STA (e.g., STA1 115-a) may suggest, request or demand to an AP (e.g., AP1 105-a) that certain TWT parameters be used in order to obtain a TWT configuration that is desirable to the current operating needs of the STA. The AP may accept the requested TWT parameters, may use instead alternate TWT parameters, may dictate which TWT parameters to use, or may simply reject the TWT parameters suggested or requested by the STA.

Once the AP has accepted or modified the TWT parameters, the TWT communications is established. In the illustrated example of the diagram 400, in conventional TWT communications, a signal such as a hardware delivery traffic indication message (HW-DTIM) may occur after a TWT set up to provide an indication to shut down parts of the STA to save power and then turn on those parts to wake up an STA after a target wake time 402 from the TWT set up. During the shutdown, medium access control (MAC) sublayer operations, physical (PHY) sublayer operations, and radio frequency (RF) operations may be disabled or turned off. This may be followed by a first TWT service period (TWT SP 1) in a TWT wake duration 404 during which transmissions and/or receptions (Tx/Rx) between the STA and the AP may take place. The first TWT service period may also be referred to as a TWT slot or simply as a slot. The first TWT service period may terminate at the end of or before the end of the TWT wake duration 404.

After the TWT wake duration 404, what follows is a TWT wake interval 406 in connection with another HW-DTIM, after which a second TWT service period (TWT SP 2) in a TWT wake duration 408 occurs during which transmissions and/or receptions (Tx/Rx) between the STA and the AP may take place. The second TWT service period may also be referred to as a TWT slot or simply as a slot. The second TWT service period may terminate at the end of or before the end of the TWT wake duration 408.

In an aspect of the diagram 400, there may be successive service period (SP) starts after the TWT wake interval 406 has elapsed or terminated since the last service period terminated.

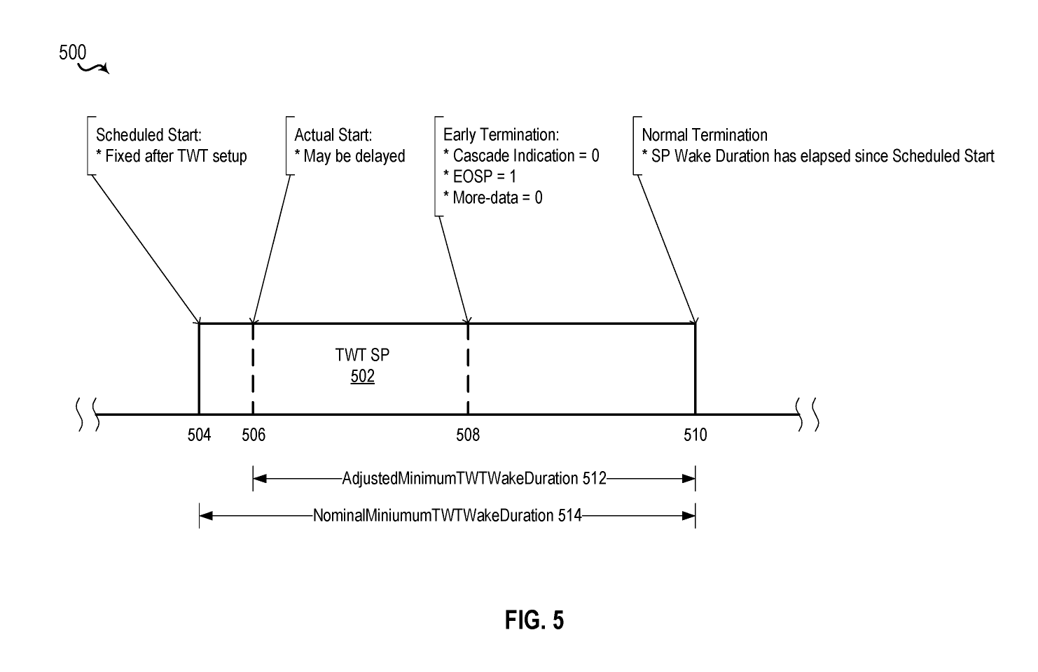

FIG. 5 shows a timeline diagram 500 illustrating baseline aspects of a start and a termination of a TWT service period.

The example in the diagram 500 illustrates differences between a scheduled start time 504 and an actual start time 506 of a TWT service period or TWT SP 502. A scheduled start time 504 may be fixed for the TWT communications after the set up is complete (e.g., as defined by the TWT parameters). In contrast to the scheduled start time 504, an actual start time 506 may be delayed with respect to the scheduled start time 504. The actual start time 506 may be different from time-to-time due to different kinds of firmware delay and/or due to hardware wake up delays.

Similarly, each TWT service period may have a normal termination or end time 510. The normal termination time 510 may be a set time or may simply be calculated based on the designated service period duration as offset from the start time. That is, the normal termination time 510 may be a nominal minimum TWT wake duration 514 that has elapsed since the scheduled start time 504. An adjusted minimum TWT wake duration 512 may represent an elapsed time from the actual start time 506 to the normal termination time 510. The normal termination time 510 is a fixed value, that is, it does not vary with the delay of the actual start time 506. After normal termination, that is, after the TWT SP 502 ends, finishes, or terminates at the normal termination time 510, an active state indicated by a power management bit in a header that is set to “0” (e.g., PM 0) may be extended. Each TWT service period may also have an early termination time 508 in which the TWT SP 502 ends, finishes, or terminates before the expected normal termination time 510. There may be at least three (3) conditions that may cause the TWT service period to terminate early to, for example, preserve power.

A first possible condition that causes early termination may be having an STA (e.g., STA1 115-a) receive a frame such as a trigger frame (see e.g., FIG. 3) from an AP (e.g., AP1 105-a) having a cascade indication (or cascade indicator) field set to “0” or zero (or flagged in a way that provides a similar indication) and the frame also contains the association identifier (AID) of the STA in one of the per-user info fields.

A second possible condition that causes early termination may be that the STA receives a frame (e.g., a trigger frame) that has an end-of-service period (EOSP) field and the EOSP field is set to “1” or one (or flagged in a way that provides a similar indication). After receiving such a frame, the STA may acknowledge the frame by sending an ACK to the AP or may not acknowledge the frame, in which case an ACK is not sent to the AP.

A third possible condition that causes early termination may be that the STA receives a frame (e.g., a trigger frame) that does not have an EOSP field and instead sets a “more data” bit or field to “0” (or flagged in a way that provides a similar indication). After receiving such a frame, the STA may acknowledge the frame by sending an ACK to the AP or may not acknowledge the frame, in which case an ACK is not sent to the AP.

The features described in the diagrams 300, 400, and 500 above, however, may not take into account the type of congestion, throughput, and/or latency constraints that may be required in dense deployments based on, for example, IEEE 802.11-ax. Another issue that may not be addressed by the baseline operations provided by TWT communications may be the implementation of VoIP in dense IEEE 802.11ax environments. In such situations, existing techniques such as the use of unscheduled automatic power save delivery (uAPSD) may not provide the needed solution. For example, uAPSD is not widely implemented or enabled, may need re-association of the STA if used, and the service period in uAPSD is fixed or static, which does not make it suitable for those cases in which dynamic background traffic is ongoing.

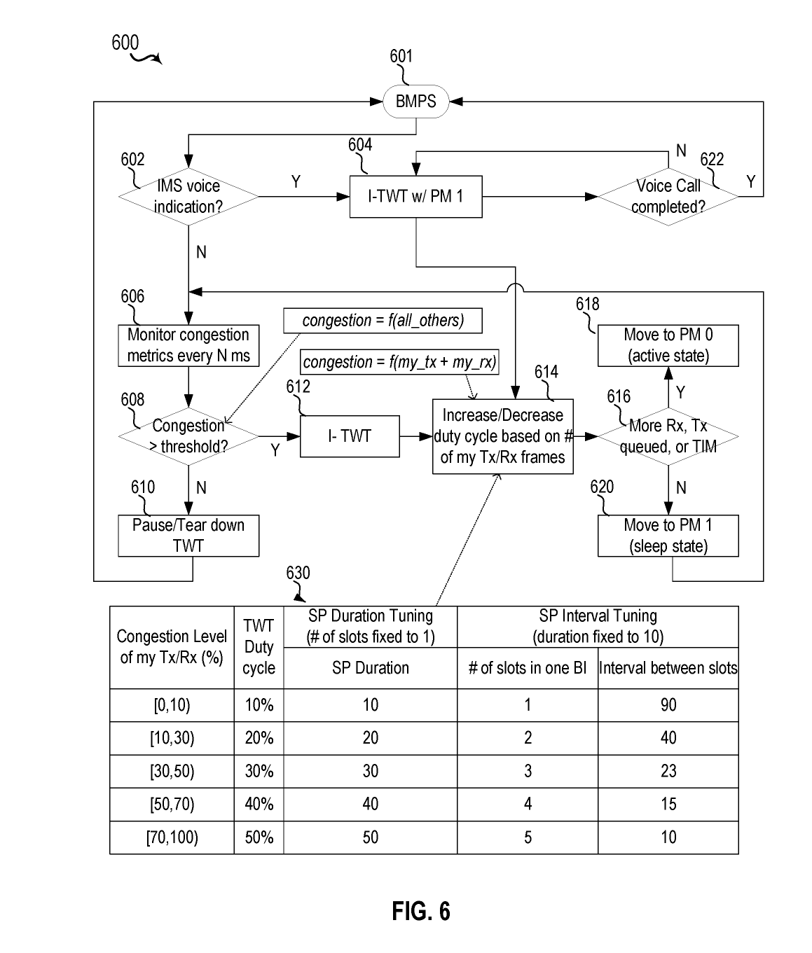

Other issues that may not be addressed by the baseline operations provided by TWT communications include the need to change or modify TWT parameters to accommodate for continuous changes in traffic amount, a need to handle pending transmissions by an STA or receptions from an AP when a service period is being terminated, a need to handle at an STA new transmission frames queued from an upper layer or an indication from an AP of buffered frames when outside of the service period, a need to handle off-channel operations when a service period is in progress, such as when a WLAN transceiver is switched to a channel other than a home channel. Aspects associated with different techniques for addressing the issues described above are provided in connection with FIGS. 6-19 below.

FIG. 6 shows a flow diagram illustrating an example method 600 for implementing TWT communications in IEEE 802.11ax for VoIP calls in accordance to various aspects of the present disclosure.

In general, for the method 600, when a VoIP call is started, an STA (e.g., STA1 115-a) may initiate an individual TWT (see e.g., FIG. 3) with a power management bit set to “1” or one (PM 1) to indicate a sleep state. Moreover, the a wake duration of the SP or TWT communications (see e.g., FIGS. 4 and 5) may be set to be the same or coincide with a VoIP packet interval. In this regard, the VoIP packet interval may be passed down from an upper layer to a component of the STA (e.g., a subcomponent of the TWT communications component 140b associated with VoIP operations) or may be detected by the component of the STA. The STA may use a duty cycle tuning approach, which may involve transitioning between PM 0 and PM 1 (PM 0 ↔ PM 1), to tune, adjust, or modify various aspects of the TWT communications (e.g., one or more TWT parameters) if some traffic other than VoIP traffic is running. That is, the techniques described in this disclosure in connection with VoIP may be applied to other types of traffic (e.g., other types of packet traffic where the packet interval can be made the same as the wake duration of the SP).

Aspects of the method 600 described below may be performed by, for example, an STA, such as the STA 115 in FIG. 18, where a processor 1812, a modem 1814, a transceiver 1802, and/or the TWT communications component 140a (or one of its subcomponents) may be executed to perform the various aspects of the method 600.

After enabling or entering into a beacon mode power save (BMPS) 601, in a determination block 602, method 600 may determine whether it has received an IP multimedia subsystem (IMS) voice indication that a VoIP call has been initiated. In an example, the IMS voice indication may indicate if the traffic is VoIP traffic or some other type of traffic. As noted above, when traffic other than VoIP traffic is detected, the STA may use a dynamic duty cycle tuning approach, which may involve transitioning between PM 0 and PM 1 (PM 0 ↔ PM 1), to tune, adjust, or modify various aspects of the TWT communications.

In response to determining that an IMS voice indication has been received or detected, the method 600 may, in block 604, initiate TWT communications with an AP (e.g., AP1 105-a). The TWT communications may be an individual, solicited TWT communications and may be enabled with PM 1. As noted above, the TWT service period wake duration may be set to the VoIP packet interval, where the VoIP packet interval may be passed down from an upper layer or may be detected.

In determination block 622, the method 600 may determine whether the VoIP call has been completed. In response to determining that the VoIP call has not been completed, the method 600 may return to block 604 and continue TWT communications in support of the transmission and/or reception of VoIP packets. On the other hand, in response to determining that the VoIP call has been completed, the method 600 may terminate and return to being in the BMPS 601.

Further, in response to determining that a VoIP call has not been initiated or that the traffic is other than VoIP traffic at the determination block 602, then method 600 may, in block 606, monitor congestion metrics every N milliseconds, where N is a value set by the executing STA. Congestion metrics may include metrics indicating a level of frame congestion associated with the STA and/or a level of frame congestion associated with other, neighboring STAs. In an aspect, congestion metrics may be tracked or monitored using counters (e.g., software or hardware counters) that monitor, for example, a number of frames (and/or a number of frames every N milliseconds) that are transmitted by the STA and/or addressed to the STA (e.g., intended to be received by the STA. A first congestion metric or congestion counter, my_tx, may be used to track or monitor the frames transmitted by the STA, while a second congestion metric or second congestion counter, my_rx, may be used to track or monitor the frames addressed to the STA. In addition, a number of frames and/or a number of frames every N milliseconds) that are transmitted by other STAs and/or addressed to other STAs (e.g., intended to be received by the other STAs) may also be tracked or monitored using counters. For example, a third congestion metric or third congestion counter, all_others, may be used to track or monitor both frames transmitted by and addressed to the other STAs. In a different implementation, separate congestion metrics or congestion counters may be used for the frames transmitted by the other STAs and the frames addressed to the other STAs.

In determination block 608, the method 600 may determine whether one or more of the congestion metrics exceeds a congestion threshold. This determination may be based on a level of congestion or congestion metric associated with other, neighboring STAs. For example, a congestion metric or congestion metric value may be identified or obtained based on or as a function of a value of the all_others counter (e.g., congestion=f(all_others)), and may then be compared to the congestion threshold to see if the congestion metric meets or satisfies (e.g., is the same or exceeds) the congestion threshold.

In response to determining that the congestion metric does meet or satisfy the congestion threshold, the method 600 may in block 610 pause, tear down, or terminate TWT communications. set-up frame In other words, if the congestion level is not sufficiently high, then there may not be a need to implement TWT techniques as the need for power savings may not be justified.

However, in response to determining that the congestion metric does meet or satisfy the congestion threshold, the method 600 may, in block 612, initiate TWT communications with an AP (e.g., AP1 105-a). The TWT communications may be an individual, solicited TWT communications, for example. set-up frame

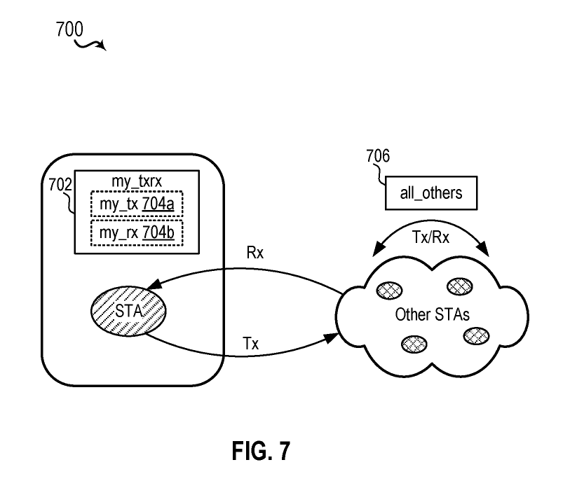

In block 614, the method 600 may adjust (e.g., may increase or decrease) the duty cycle (also referred to as the TWT duty cycle; see e.g., FIG. 7) of a current TWT communications based on the congestion as perceived by the STA. In this case, a congestion metric or congestion metric value may be identified or obtained based on or as a function of a value of the my_tx and my_rx counters (e.g., congestion=f(my_tx+my_rx)), and may then be used to determine whether to increase or decrease the duty cycle. More detailed aspects of the duty cycle are described below, however, it generally refers to an amount of time used for a TWT service period relative to an interval between TWT service periods. The duty cycle may be reduced in connection with a reduction in the level of congestion perceived by the STA, while it may otherwise be increased in connection with an increase in the level of congestion perceived by the STA. While the STA may make these adjustments, In one aspect, the AP may accept or reject the proposed duty cycle updates. Moreover, the increase or decrease may be based on, for example, a table (e.g., a look-up-table or LUT) as illustrated in table 630, which lists different congestion levels based on transmission and/or reception of frames by the STA, and provides corresponding duty cycle information, including SP duration tuning and SP interval tuning. The table 630 may be stored in a memory of the STA along with additional information such as TWT parameters and/or counters, for example.

In determination block 616, the method 600 may determine whether any additional frames remain for transmission by the STA and/or whether the STA is attempting to receive additional frames form the AP. This determination may be based at least in part on a number of frames or packets that are queued for transmission to the STA and/or by the STA, or by a traffic indication map (TIM).

In response to determining that additional frames need to be exchanged between the AP and the STA, the method 600 may, in block 618, cause the STA to move to an active state (PM 0).

However, in response to determining that there are no frames remaining to be exchanged, the method 600 may, in block 620, move to a sleep state (PM 1). The method 600 may then terminate or return to monitoring congestion metrics in block 606.

FIG. 7 shows a diagram 700 illustrating aspects of identifying or obtaining congestion metrics by an STA, such as the STAs 115 described herein.

Various aspects of the present disclosure utilize congestion metrics identified or obtained for an STA, where the congestion metrics can be of two kinds: one kind is associated with the STA and another kind is associated with other STAs that are neighboring STAs. These congestions metrics may be used as described above to adjust or tune aspects of TWT communications, including a TWT duty cycle. As illustrated in the diagram 700, an STA (e.g., STA 115-a) may determine its own congestion metrics 702, which may be maintained, tracked, or monitored in a counter or similar structure. In this example, the congestion metrics 702 are tracked in a counter labeled my_txrx, which maintains information associated with a number of frames received and addressed to the STA, and/or a number of frames transmitted by the STA. The number of frames transmitted by the STA may be tracked separately in, for example, the counter my_tx 704a, while the number of frames received and addressed to the STA may be tracked separately in, for example, the counter my_rx 704b. In an aspect, frames for which the transmitter address (TA) is the address of the STA may be counted as frames transmitted by the STA, while frames for which the receiver address (RA) is the address of the STA may be counted as frames received by the STA. The congestion metrics 706 associated with other, neighboring STAs may be maintained, tracked, or monitored in a counter or similar structure. In this example, the congestion metrics 706 are tracked in a counter labeled all_others, which maintains information associated with a number of frames received and addressed to other STAs and a number of frames transmitted by other STAs. In an aspect, frames for which the transmitter address (TA) is an address other than the address of the STA may be counted as frames transmitted by other STAs, while frames for which the receiver address (RA) is an address other than the address of the STA may be counted as frames received by other STAs. When tracking the congestion metrics 706, a frame to be counted for purposes of congestion analysis may require that both the TA and the RA be address different from the address of the STA.

The congestion metrics 702 and 706 may be used as described above in connection with the method 600 in FIG. 6. For example, an STA may set up individual TWT communications with an AP if the congestion metrics 706 (e.g., all_others counter) meet (e.g., greater than) a first congestion threshold. If after the TWT communications is set up the congestion metrics 706 do not meet a second congestion threshold, then the STA may tear down or terminate the TWT communications with the AP (e.g., STA may send a termination request to the AP).

In various aspects the second congestion threshold may be equal to or less than the first congestion threshold. During TWT communications, the amount of traffic can change significantly and the current duty cycle (or TWT duty cycle) being used by the STA for the TWT communications may not be adequate. For example, if the amount of traffic increases greatly, the current duty cycle may not be enough to properly address the traffic levels.

Similarly, if the amount of traffic decreases greatly, the current duty cycle may be more than sufficient and the STA may be awake longer than needed. As such a dynamic duty cycle tuning or adjusting is needed to achieve throughput requirements that can change. As used in this disclosure, the duty cycle may identify a percentage of the channel bandwidth that is being used by means of a service period (or TWT service period).

As described above in connection with block 614 of the method 600 in FIG. 6, the duty cycle may be dynamically increased or decreased based at least in part on a congestion metric or congestion metric value associated with the STA itself (e.g., congestion metrics 702), where this congestion metric may be based on or is a function of, for example, a value of a my_tx counter (e.g., my_tx counter 704a) and/or a value of a my_rx counter (e.g., my_rx counter 704b).

The duty cycle (or TWT duty cycle), duty cycle, may be represented by the following expression:

duty_cycle=SP_duration/(SP_period)=SP_duration/(SP_duration+SP_interval),

where SP_duration is the duration of the service period, SP_period is the period or interval from one service period to the next service period, and SP_interval is the interval between the end of one service period and the start of a next service period.

Based on the expression provided above, an STA may adjust the current duty cycle by increasing or decreasing any one of the service period duration, the service period interval, or the service period. A mechanism for performing such an adjustment or tuning of the duty cycle is described below.

As noted above, the tuning of the duty cycle is based at least in part on the congestion or congestion metric associated with STA itself (e.g., congestion metrics 702, my_tx counter 704a, and/or my_rx counter 704b). The congestion metric is continuously monitored in order to determine a number of frames (e.g., frames transmitted by the STA and/or frames received and addressed to the STA) every N seconds. The congestion metric may correspond to a congestion level as illustrated in the table 630 in FIG. 6. In the table 630, there are shown five (5) congestion levels covering different percentages. For example, a first congestion level covers the range [0, 10), the second congestion level covers the range [10, 30), the third congestion level covers the range [30, 50), the fourth congestion level covers the range [50, 70), and the fifth congestion level covers the range [70, 100). Table 630 is illustrative and may include more or fewer congestion levels. Moreover, in other implementations the percentage ranges for the congestion levels may be different from those in the table 630.

The STA may then map the congestion (e.g., the congestion level or congestion metric) to a corresponding duty cycle. For example, using the table 630, a congestion level that falls in the [10, 30) percentage range may require a corresponding duty cycle of 20%. When the congestion level or congestion metric changes based on the monitoring of the frames, it may be necessary to change the duty cycle. For example, if a current duty cycle is 20% but the congestion levels falls in the [30, 50) percentage range, then the duty cycle needs to be increased to 30%. Similarly, if a current duty cycle is 20% but the congestion levels falls in the [0, 10) percentage range, then the duty cycle needs to be decreased or reduced to 10%.

To increase the duty cycle, the STA may increase the SP_duration or decrease the SP_interval. Similarly, to decrease the duty cycle the STA may decrease the SP_duration or may increase the SP_interval. To make these changes to the SP_duration and/or the SP_interval, the STA may need to change the TWT parameters associated with the TWT communications. One option is for the STA to send a TWT set-up frame on the existing session of TWT communications to change the appropriate TWT parameters on the fly. If peer STAs participating in the existing session do not support these changes, then the STA may need to tear down the current session of the TWT communications and set up a new session with the appropriate TWT parameters.

Duty cycle tuning as described herein may not occur regularly, for example, it may only occur every few seconds. Because the re-negotiation of TWT parameters tends to incur extra management frame exchange overhead the duty cycle tuning is infrequent.

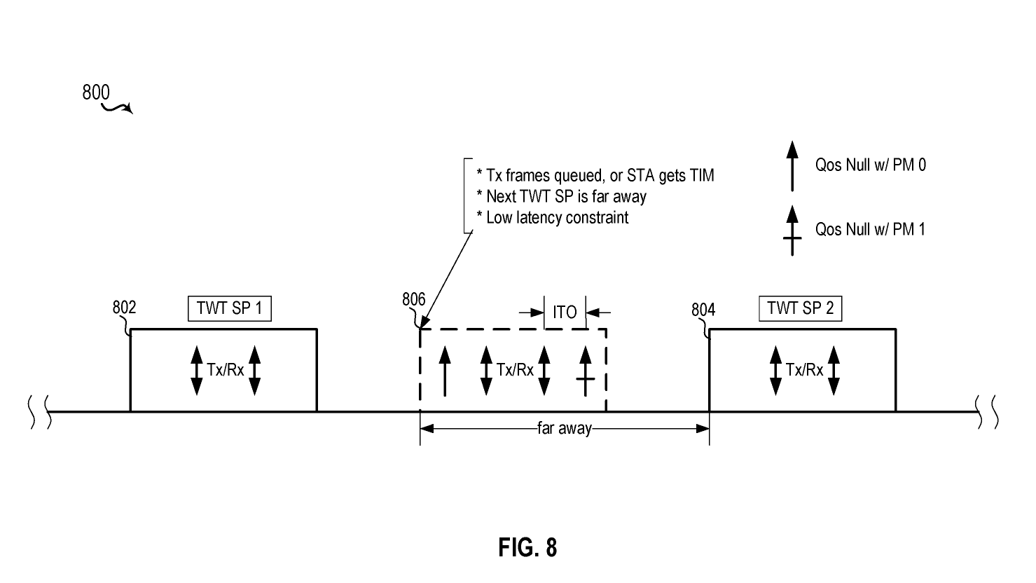

FIG. 8 shows a timeline diagram 800 illustrating an example of transitioning between power management settings, PM 0 and PM 1, in accordance with various aspects of the present disclosure. To promote power savings, an STA (e.g., STA1 105-a) may transition between power management settings, that is, the STA may transition from an active state (PM 0) to a sleep state (PM 1) or from a sleep state to an active state. This approach may allow the STA to handle or address conditions that occur after a service period has terminated but before a next or subsequent service period begins.

For example, as shown in the diagram 800, a first service period (TWT SP 1) 802 takes place during which an STA may exchange data (Tx/Rx) with an AP as part of TWT communications scheduled by the AP that involves the STA and other STAs. After an interval of time, a second service period (TWT SP 2) 804 takes place during which the STA may exchange data (Tx/Rx) with the AP as part of the TWT communications.

After the first service period 802 has terminated and the associated Tx/Rx completed, the STA may move into a sleep state (e.g., PM 1) and may remain in that state until the second service period 804. Under some conditions, the STA may need to transmit and/or receive frames after the first service period 802 has terminated, however, because of low latency constrains the STA may not be able to wait until the second service period 804 is available to wake up from the sleep state to an active state in order to perform the needed Tx/Rx. For example, the STA may need to transmit frames waiting in the transmission queue provided by an upper layer or may need to receive frames buffered at the AP (e.g., a beacon such as a traffic indication map (TIM) beacon indicates frames buffered at the AP). Accordingly, the STA may determine that the length or amount of time between the time 806 at which the additional frames transmissions/receptions are indicated and the next available service period (the second service period 804) is too much (e.g., too far away) to meet the latency requirements indicated by a host operation or host-level software. Thus, the STA may transition to an active state (PM 0) at or after a time 806 and commence transmission or reception of the additional frames.

When a determination is made that the amount of time to the next service period is too long (e.g., by calculating the time difference between the start of the second service period 804 and time 806 and comparing it to a threshold time based on the latency requirements), the STA may move to an active state (PM 0) by sending a quality-of-service (QoS) null frame with PM 0 to the AP. Once in the active state, the STA may proceed to transmit and/or receive (Tx/Rx) the queued frames. After completion of the Tx/Rx the STA may move back to a sleep state (PM 1) by sending a QoS null frame with PM 1 to the AP. The STA may send the QoS null frame to move to the sleep state after, for example, a period of inactivity indicated by an inactivity timeout (ITO) indicator.

Unlike the duty cycle tuning, the transitioning between power management settings, PM 0 and PM 1, may occur frequently as indications of buffered transmission frames and/or TIM beacons may occur at any time.

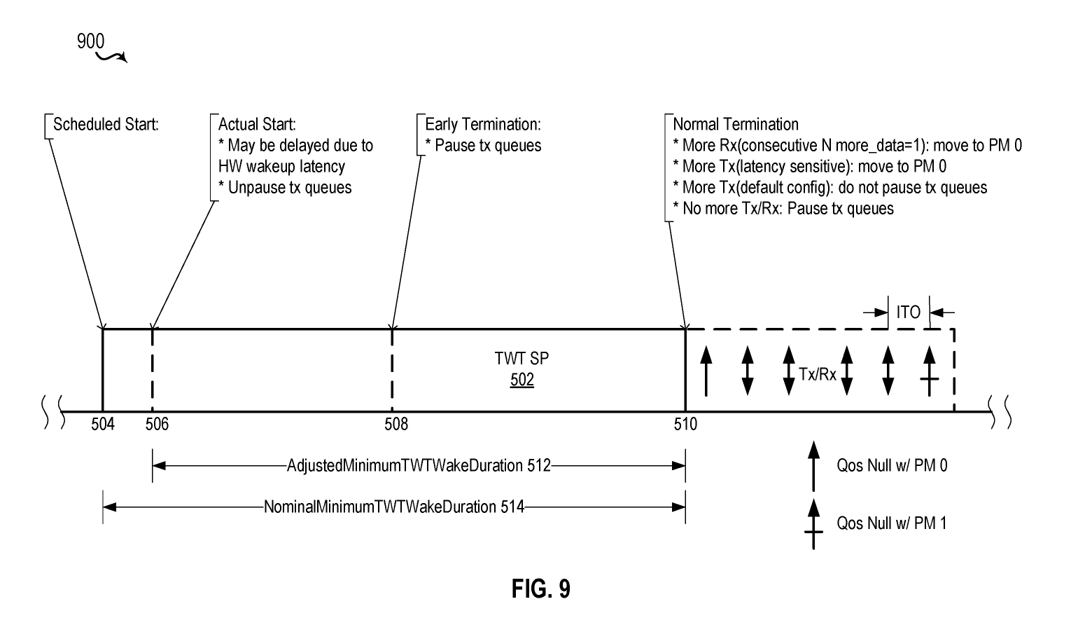

FIG. 9 shows a timeline diagram 900 illustrating termination of service periods while there are pending frames for transmission or reception in accordance with various aspects of the present disclosure.

The diagram 900 shows the TWT service period or TWT SP 502 shown in FIG. 5, including the scheduled start time 504, the actual start time 506, the early termination time 508, and the normal termination time 510, as well as the adjusted minimum TWT wake duration 512 and the nominal minimum TWT wake duration 514. As described above, the actual start time 506 may be caused by hardware wakeup latency and any frames queued for transmission at an STA (e.g., STA1 115-a) are paused until the actual start time 506. Similarly, the early termination time 508 may require that the STA pause the transmission queues. When the TWT service period 502 terminates at the normal termination time 510, if there are no pending frames to be transmitted by the STA or frames to be received by the STA, then the STA may pause the transmission queues.

One of the issues that may arise in TWT communications is that there may be pending frames to be transmitted or received by the STA while the TWT service period 502 service period is being terminated (e.g., at normal termination time 510). With respect to any frames that are still pending to be received by the STA, the STA may first detect that there are, or there likely are, frames buffered at the AP for transmission to the STA. To do so, the STA may determine if there are N consecutive frames (e.g., a threshold number of frames) that have been received with the “more data” bit set to 1 as an indication that there are additional frames buffered at the AP to be transmitted to the STA. That is, the STA may monitor the “more data” bit of a threshold number of frames to determine if it is to expect additional frames from the AP after the normal termination time 510. If additional frames from the AP are expected, then the STA may move to an active state (PM 0) after the normal termination time 510 by, for example, transmitting or sending a QoS null frame with PM 0 to the AP. While in the active state, the STA may receive any additional frames from the AP and may move to a sleep state (PM 1) after a certain amount of time of inactivity (ITO) by transmitting or sending a QoS null frame with PM 1 to the AP.

With respect to any frames that are still pending in the transmission queues of the STA, if there are any latency constraints that would require the frames in the transmission queues to be transmitted as early as possible, the STA may move to an active state (PM 0) after the normal termination time 510 by, for example, transmitting or sending a QoS null frame with PM 0 to the AP. This latency-sensitive approach may occur when latency requirements are provided by, for example, a host operation or host-level software in the STA. In the case that there are no latency constraints (e.g., a default configuration) but there are pending frames in the transmission queues of the STA, the STA may not pause the transmission queues and these pending frames may be sent out while in a sleep state (with PM 1).

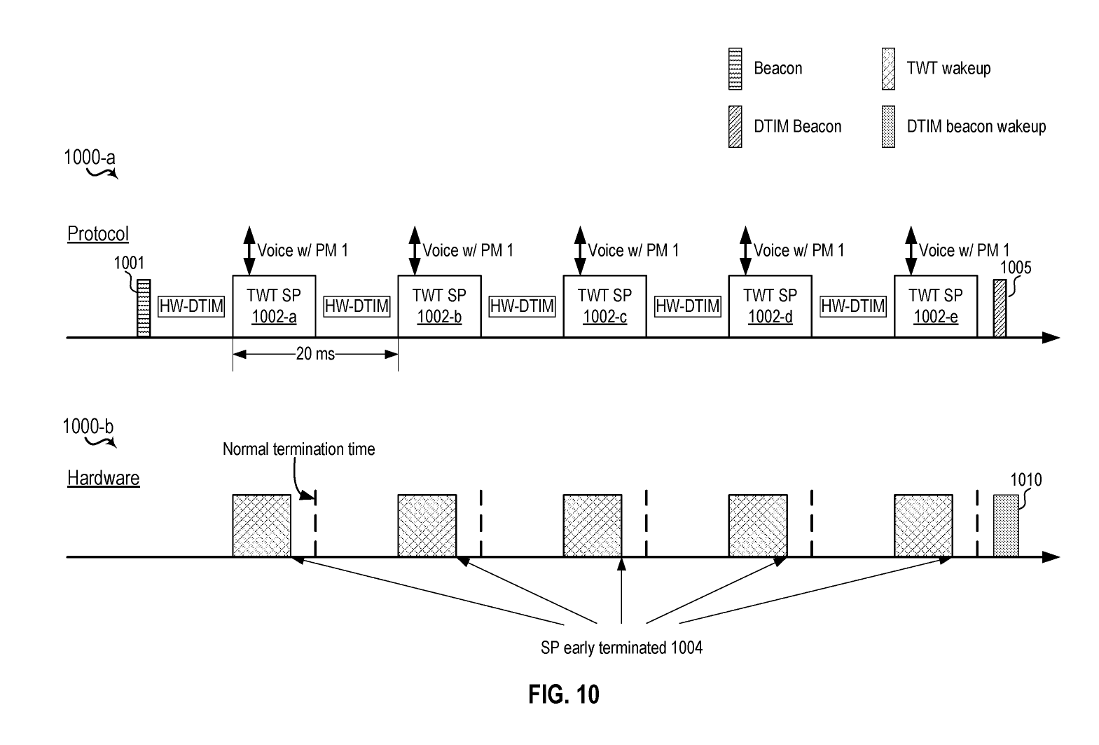

FIG. 10 shows timeline diagrams 1000-a and 1000-b illustrating an example of TWT communications implemented for a VoIP call in accordance with various aspects of the present disclosure.

The diagram 1000-a shows a timeline in a protocol (e.g., protocol stack or protocol software) in which first a beacon 1001 is transmitted to an STA (e.g., STA1 115-a) by an AP (e.g., AP1 105-a). The beacon 1001 may include, for example, a traffic information map (TIM) information element. After the beacon 1001 is received by the STA, there may be multiple service periods that occur in connection with the STA during which the STA may exchange data (Tx/Rx) with the AP. In this example, service periods or TWT SPs 1002-a, 1002-b, 1002-c, 1002-d, and 1002-e are shown. Also shown after the TWT SP 1002-e is a DTIM beacon 1005, which may include an delivery traffic indication message (DTIM) information element.

In the diagram 1000-a, a period between service periods (e.g., a time difference between scheduled starts of service periods) may be set to be the same or coincide with a period of a VoIP call. In an example, the period or time between service periods may be set to 20 milliseconds or 30 milliseconds to match or coincide with the period of the VoIP call.

In each of the TWT SPs 1002-a, , 1002-e, the STA may exchange VoIP frames with the AP. In an aspect, the STA may transmit frames to the AP with PM 1. In between service periods, the STA may shut down certain operations (and related components) such as MAC layer operations, PHY layer operations, and RF operations. The shutdown may be signaled or controlled by an HW-DTIM.

The diagram 1000-b shows a timeline in hardware in which an early termination 1004 may take place for the TWT SPs 1002-a, , 1002-e if the traffic is insufficient to warrant the full duration of the service periods. By having early termination when there are low traffic levels, the STA may save additional power.

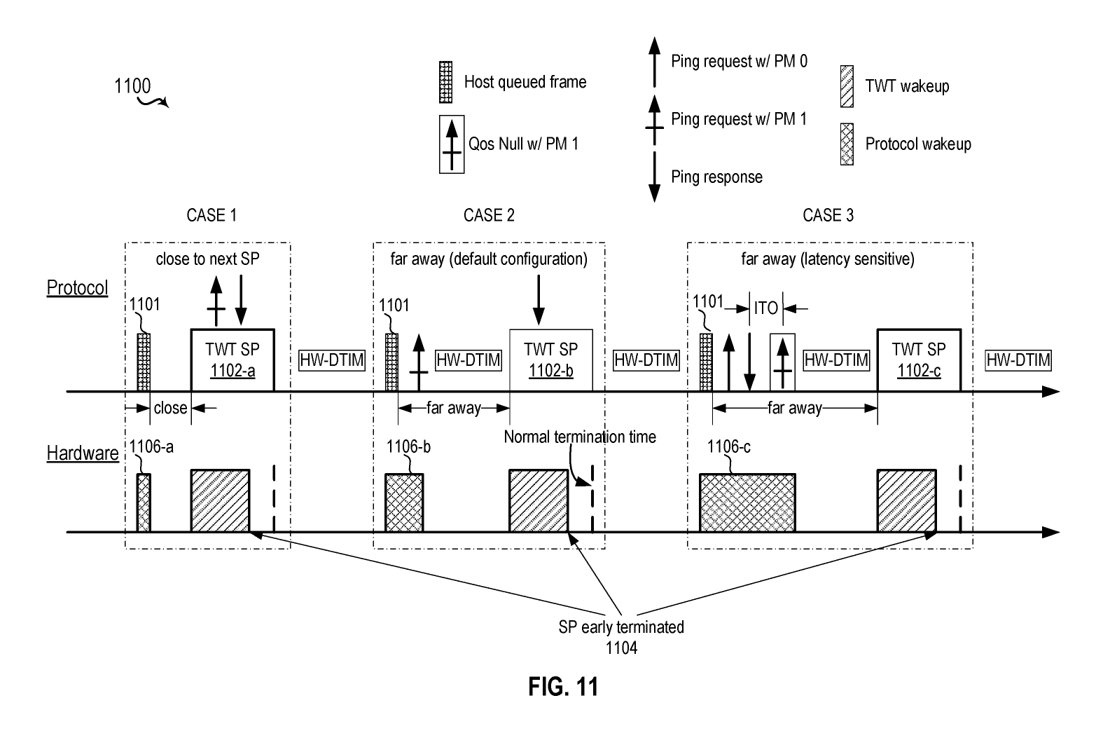

FIG. 11 shows a timeline diagram 1100 illustrating different examples of using an uplink ping when transmission frames are queued from an upper layer in accordance with various aspects of the present disclosure.

In an STA (e.g., STA1 115-a), WLAN firmware (e.g., firmware running on the TWT communications component 140a in FIGS. 1 and 18) may receive frames for transmission (transmission frames) from an upper layer of the protocol stack. Below are described three (3) cases or scenarios of how the STA may handle the frames to be transmitted.

In a first case or first scenario (CASE 1), the next service period after an indication is received that there are frames queued for transmission may be close to the indication. That is, the time between the indication that there are frames queued for transmission and the start of the next available service period may be within a threshold value such that, for example, latency constraints may not be an issue. Latency constraints or requirements may be provided to a TWT module in the STA (e.g., TWT communications component 140a) from a WLAN latency manager in the STA. In this scenario, the STA may determine to wait and transmit the frames in the next available service period. For example, a top portion of the diagram 1100 shows a protocol in which the first scenario (CASE 1) is illustrated on the left-most side. After an indication 1101 is provided (e.g., by an upper layer) that the STA has frames queued for transmission before a next service period (TWT SP 1102-a), the STA may determine that the next service period is sufficiently close and may wait to transmit the queued frames in the next or coming service period. As shown, during the TWT SP 1102-a, the STA may also ping the respective AP (e.g., a ping request with PM 1) and the AP may provide a response within the TWT SP 1102-a (e.g., a ping response).

In a second case or second scenario (CASE 2), the next service period after an indication is received that there are frames queued for transmission may be far away from the indication. That is, the time between the indication that there are frames queued for transmission and the start of the next available service period may be greater than a threshold value but not so much greater that latency constraints become an issue. In this scenario, the STA may determine to transmit the queued frames immediately with PM 1. For example, the top portion of the diagram 1100 shows the protocol in which the second scenario (CASE 2) is illustrated in the middle. After an indication 1101 is provided (e.g., by an upper layer) that the STA has frames queued for transmission before a next service period (TWT SP 1102-b), the STA may determine to send or transmit the queued frames immediately and not wait until the next service period. As shown, the STA may also ping the respective AP (e.g., a ping request with PM 1) before the TWT SP 1102-b and the AP may provide a response within the TWT SP 1102-a (e.g., a ping response). After the ping request by the STA, an HW-DTIM may occur and portions of the STA may shut down until the TWT SP 1102-b.

In a third case or third scenario (CASE 3), the next service period after an indication is received that there are frames queued for transmission may be far away from the indication. That is, the time between the indication that there are frames queued for transmission and the start of the next available service period may be greater than a threshold value and is such that latency constraints become an issue. In this scenario, the STA may determine to move to an active state (PM 0) to do a full Tx/Rx with the AP with minimum delay. For example, the top portion of the diagram 1100 shows the protocol in which the third scenario (CASE 3) is illustrated on the right-most side. After an indication 1101 is provided (e.g., by an upper layer) that the STA has frames queued for transmission before a next service period (TWT SP 1102-c) and there is a low latency constraint, the STA may determine to move to an active state (PM 0) for full Tx/Rx and not wait until the next service period. As shown, the STA may transmit after the indication 1101 a ping request with PM 0 to the AP before the TWT SP 1102-c and the AP may provide a response (e.g., a ping response) also before the TWT SP 1102-c. After the AP response (e.g., after a period of inactivity or ITO), the STA may move back to a sleep state (PM 1) by transmitting a QoS null frame with PM 1 to the AP, followed by a shutdown period (e.g., HW-DTIM) before the TWT SP 1102-c.

The bottom portion of the diagram 1100 shows a corresponding hardware aspects to the protocol aspects described above. In connection with the hardware aspects, protocol wakeups 1106-a, 1106-b, and 1106-c are shown that correspond to the indications 1101 that there are frames queued for transmission. Moreover, within the TWT SPs early termination 1104 may be possible if the traffic is low.

It is to be understood that indications of frames queued for transmission include those instances in which a single frame is queued for transmission as well as instances in which multiple frames are queued for transmission.

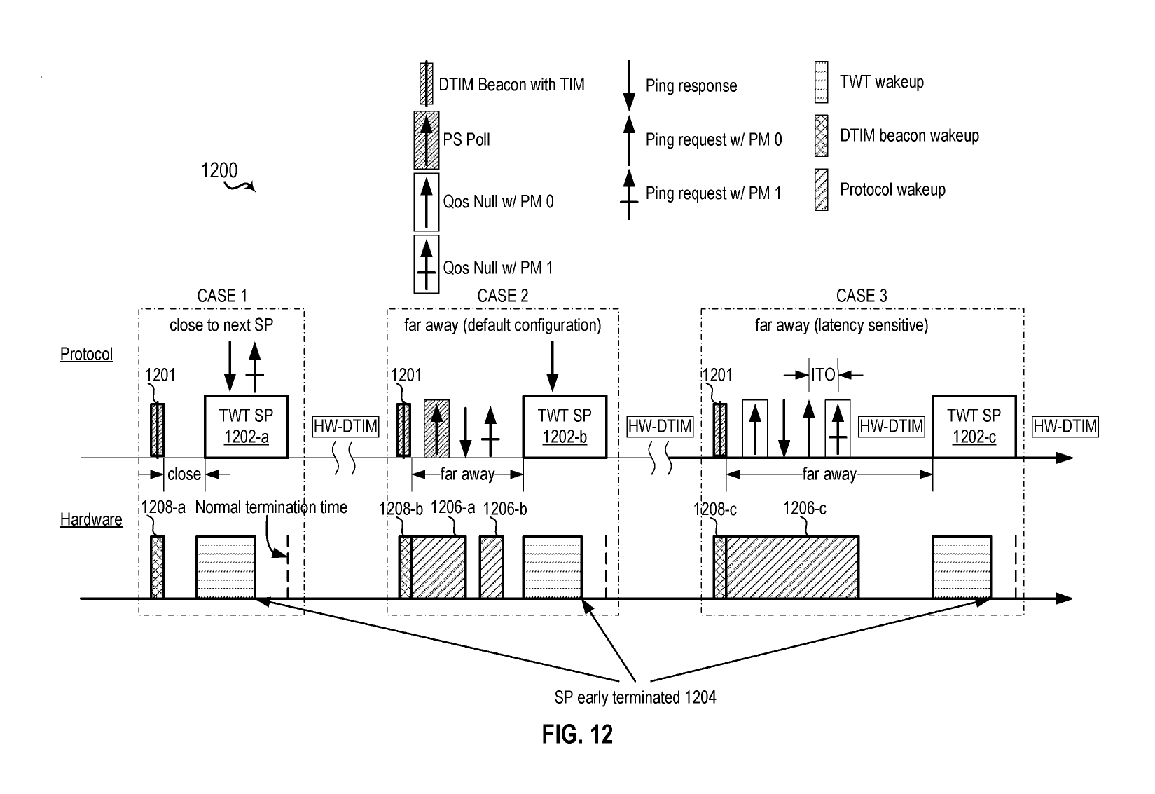

FIG. 12 shows a timeline diagram 1200 illustrating different examples of using a downlink (DL) ping when frames are buffered at an AP in accordance with various aspects of the present disclosure.

In general, downlink (DL) frames are not to be sent outside a service period directly to an STA (e.g., STA1 115-a) by an AP (e.g., AP1 105-a). That is, frames buffered at the AP are not to be sent to the STA directly. Instead, the AP may be able to send the buffered frames to the STA in coming service periods (TWT service periods). If not, the ping requests may be buffered at the AP and indicated to the STA via TIM information elements in beacons. Below are described three (3) cases or scenarios of how the STA may handle receiving the TIM interrupts (e.g., in beacons) indicating frames buffered at the AP for transmission to the STA.

In a first case or first scenario (CASE 1), the next service period after an indication is received that there are frames buffered at the AP for transmission may be close to the indication. That is, the time between the indication that there are frames buffered for transmission at the AP and the start of the next available service period may be within a threshold value such that, for example, latency constraints may not be an issue. Latency constraints or requirements may be provided to a TWT module in the STA (e.g., TWT communications component 140a) from a WLAN latency manager in the STA. In this scenario, the STA may determine to wait until the AP sends the buffered frames in the next available service period. For example, a top portion of the diagram 1200 shows a protocol in which the first scenario (CASE 1) is illustrated on the left-most side. After a beacon 1201 with TIM is received by the STA before a next service period (TWT SP 1202-a) indicating that there are frames buffered for transmission at the AP, the STA may determine that the next service period is sufficiently close and may wait to have the AP send the buffered frames in the next or coming service period. As shown, during the TWT SP 1202-a, a ping response is queued and the STA may send a ping to the AP (e.g., a ping request with PM 1).

In a second case or second scenario (CASE 2), the next service period after an indication is received that there are frames at the AP buffered for transmission may be far away from the indication. That is, the time between the indication that there are frames buffered for transmission at the AP and the start of the next available service period may be greater than a threshold value but not so much greater that latency constraints become an issue. In this scenario, the STA may determine to send a PS-Poll (power save poll) frame to the AP to fetch the buffered frame(s). For example, the top portion of the diagram 1200 shows the protocol in which the second scenario (CASE 2) is illustrated in the middle. After a beacon 1201 with TIM is received by the STA before a next service period (TWT SP 1202-b) indicating that there are frames buffered for transmission at the AP, the STA may send a PS-Poll frame to the AP to fetch the buffered frame(s). As shown, before the TWT SP 1202-b and after the PS-Poll frame is sent, a ping response is queued from a host and the STA may send a ping to the AP (e.g., a ping request with PM 1).

In a third case or third scenario (CASE 3), the next service period after an indication is received that there are frames buffered for transmission at the AP may be far away from the indication. That is, the time between the indication that there are frames at the AP buffered for transmission and the start of the next available service period may be greater than a threshold value and is such that latency constraints become an issue. In this scenario, the STA may determine to move to an active state (PM 0) to do a full Tx/Rx with the AP with minimum delay. For example, the top portion of the diagram 1200 shows the protocol in which the third scenario (CASE 3) is illustrated on the right-most side. After a beacon 1201 with TIM is received by the STA before a next service period (TWT SP 1202-c) indicating that there are frames buffered for transmission at the AP, the STA may determine to move to an active state (PM 0) for full Tx/Rx and not wait until the next service period. As shown, after the beacon 1201, the STA may transmit a QoS null frame with PM 0, have a ping response queued, and transmit a ping request with PM 0 to the AP. After the Tx/Rx takes place and after a period of inactivity or ITO, the STA may transmit a QoS null frame with PM 1 to return to the sleep state (which may include a HW-DTIM to shut down portions of the STA until the STA awakes during the TWT SP 1202-c).

The bottom portion of the diagram 1200 shows a corresponding hardware aspects to the protocol aspects described above. In connection with the hardware aspects, protocol wakeups 1206-a, 1206-b, and 1206-c are shown as well as DTIM beacon wakeups 1208-a, 1208-b, and 1208-c. Moreover, within the TWT SPs early termination 1204 may be possible if the traffic is low.

It is to be understood that indications of frames buffered for transmission at the AP include those instances in which a single frame is buffered for transmission at the AP as well as instances in which multiple frames are buffered for transmission at the AP.

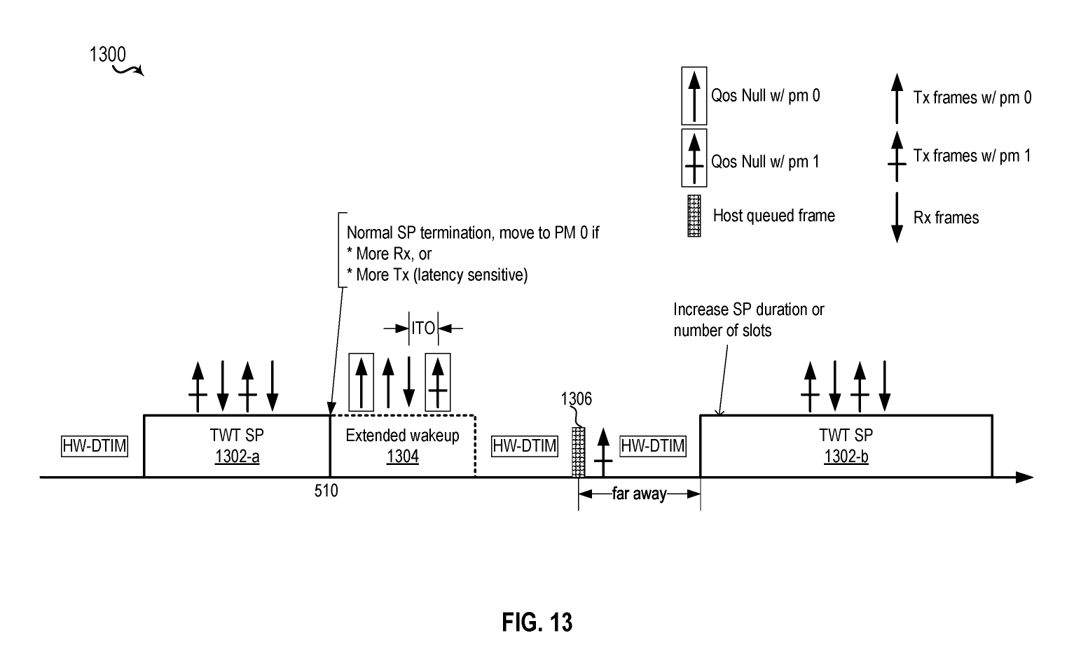

FIG. 13 shows a timeline diagram 1300 illustrating examples of modifications to TWT communications based on changes in throughput in accordance with various aspects of the present disclosure.

In case of changes that produce large traffic or throughput requirements, such as when online video applications or downloading operations are taking place, it may be possible to make certain modifications to the TWT communications to accommodate for these changes.

For example, when the amount of traffic or throughput is increased significantly, at first an STA (e.g., STA1 115-a) may move to an active state (PM 0) if the service period has terminated. That is, the STA may be able to extend the duration of a current service period or perform an extended wakeup. If the amount of heavy traffic continues, the STA may increase the duty cycle (or TWT duty cycle) to facilitate the running traffic. If the duty cycle is saturated (e.g., the duty cycle cannot be increased further based at least in part on the reasons described above) and there is still a significant amount of traffic (e.g., frames) buffered, the STA may continue moving to an active state (PM 0 By doing so, the STA may be able to use 100% of the bandwidth to address the throughput requirements.

As shown on the left-most side of the diagram 1300, during a current service period (TWT SP 1302-a) an STA may transmit frames with PM 1 and may receive frames. If the amount of traffic increases significantly, the STA may move to an active state PM 0 after normal termination of the service period. This is shown in the extended wakeup 1304 where the STA may in effect extend the duration of the TWT SP 1302-a beyond the normal termination time 510. For example, the STA, as a result of the increased traffic levels, may determine to move to PM 0 after normal termination if there are more frames to be received or if there are more frames to be transmitted and there are latency constraints (e.g., the frames queued for transmission are latency sensitive). When determining to move to PM 0, the STA may then transmit a QoS null frame with PM 0 to the AP, after which Tx/Rx may take place during the extended wakeup 1304 by transmitting frames with PM 0 and receiving frames. After a period of inactivity or ITO, the STA may move to a sleep state by transmitting a QoS null frame with PM 1 to the AP leading to the termination of the extended wakeup 1304.

The change to the duty cycle described above in connection with increases in traffic or throughput is illustrated on the right-most side of the diagram 1300. In this case, after an indication (e.g., host indication 1306) that there a frames queued for transmission, the STA may determine that the next service period (e.g., TWT SP 1302-b) is too far away (e.g., a time to the next service period is greater than a threshold) and may transmit the queued frames immediately with PM 1, after which a HW-DTIM operation may take place where at least some portions of the STA are shut down before the STA awakens for the TWT SP 1302-b. For the TWT SP 1302-b, the STA may either increase the duration of the service period compared to the duration of the TWT SP 1302-a, or may increase the number of slots or service periods that occur to increase the duty cycle. As described above, the extension of the service period duration and the change in the duty cycle may be combined to handle large amounts of traffic or throughput.

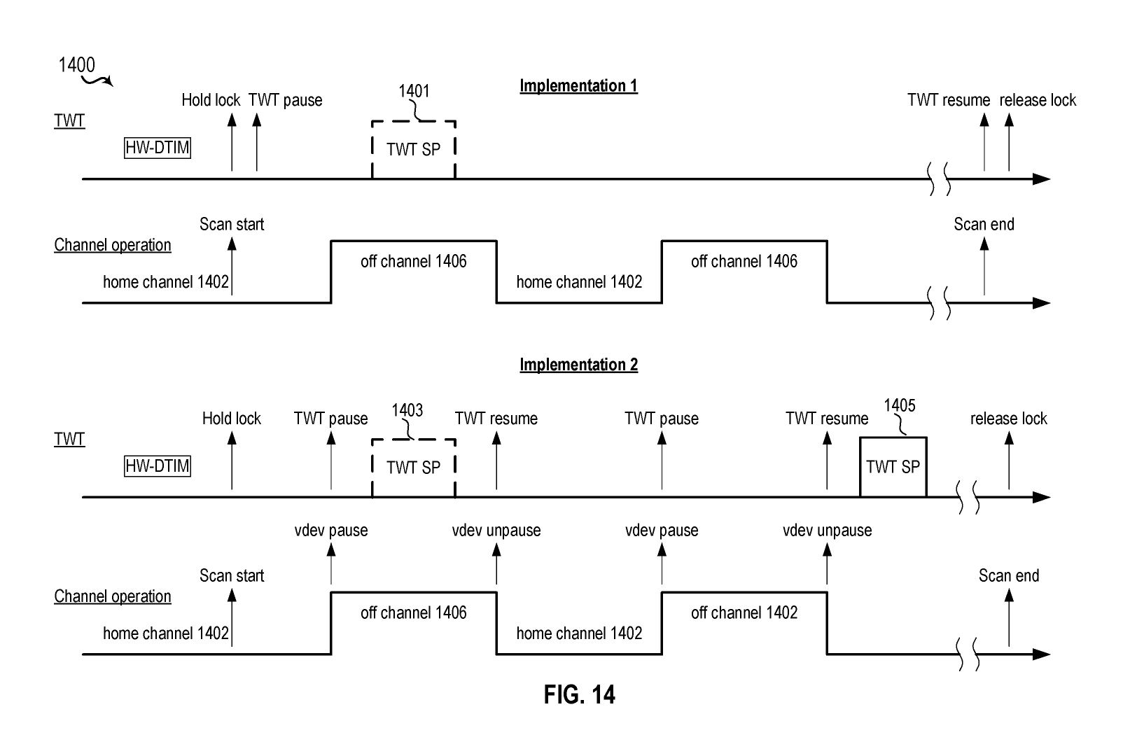

FIG. 14 shows a diagram 1400 illustrating examples of off-channel operations in TWT communications in accordance with various aspects of the present disclosure.

In some scenarios, if a service period of TWT communications is in progress at an STA (e.g., STA1 115-a) and a WLAN transceiver (e.g., a transceiver handling WLAN communications) has switched to an off-channel (e.g., a channel different from a home channel), a peer STA or an AP (e.g., AP1 105-a) may continue to send traffic to the STA, which because it is in the off-channel causes frames to be dropped and, consequently, the rate to drop as well.

Switching to off-channel operations may be sustained or temporary. For sustained off-channel operations, such as multi-STA concurrency or WLAN/Bluetooth concurrency), the TWT communications may be disabled (e.g., paused) or teared down. For temporary off-channel operations, such as scanning (e.g., to determine a suitable AP), the TWT communications may be enabled but the service period may be paused. In this regard, one implementation (Implementation 1 in the diagram 1400) may be to pause the TWT communications for the entire duration of the scan, and then resume after the scan is completed. In another implementation (Implementation 2 in the diagram 1400), the TWT communications may be paused every time a transceiver switches to the off-channel, and the TWT communications are resumed every time the home channel is back on.

For example, in Implementation 1 of temporary off-channel operations due to scanning, a scan starts during home channel 1402 operations. For the TWT communications, a lock is placed on hold and the TWT communications are paused. Because the TWT communications are paused, a TWT service period (SP) 1401 that would have otherwise occurred does not take place when channel operations switch to off-channel 1406. Channel operations may further switch back to the home channel 1402 and then to the off-channel 1406, while the TWT communications are not resumed until the scan ends or is completed. After the TWT communications are resumed, the lock may be released.

In Implementation 2 of temporary off-channel operations due to scanning, a scan starts during home channel 1402 operations. For the TWT communications, a lock is placed on hold. The TWT communications are paused at a time the channel operations switch to off-channel 1406 (e.g., when a virtual device or vdev is paused), and the TWT communications resume at a time the channel operations switch back to the home channel 1402 (e.g., when the virtual device or vdev is unpaused). Because the TWT communications are paused, a TWT SP 1403 that would have otherwise occur does not take place when channel operations switch to the off-channel 1406. This approach is followed every time the channel operations switch to the off-channel 1406. A TWT SP scheduled after TWT communications resume, such as the TWT SP 1405, is performed. When the scan ends or is completed, the lock is released.

It is to be understood that switching to an off-channel as described above need not imply that when multiple switches occur they are all to the same off-channel. In some scenarios, a WLAN transceiver may switch to one off-channel and then switch to different off-channels at a subsequent instance of time.

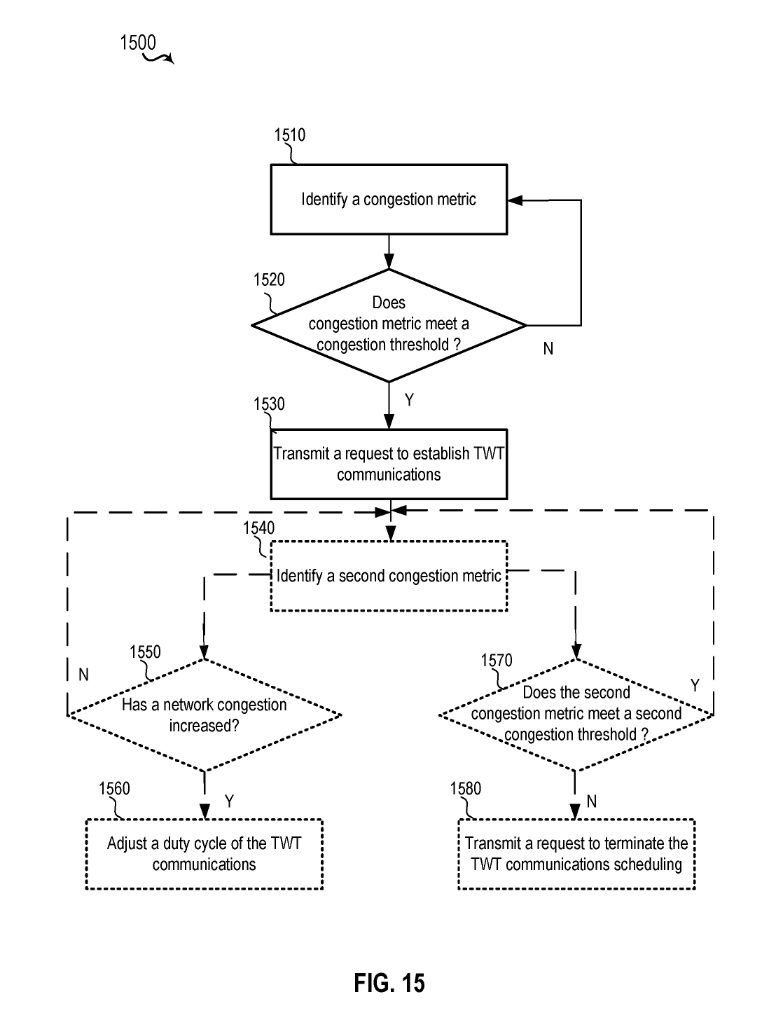

FIG. 15 shows a flow diagram of a method 1500 for implementing techniques for TWT communications in accordance with various aspects of the present disclosure. For clarity, the method 1500 is described below with reference to an STA such as the STAs in FIGS. 1 and 18. Aspects of the method 1500 described below may be performed by, for example, an STA, such as the STA1 115-a in FIG. 1 or the STA 115 in FIG. 18, where the processor 1812, the modem 1814, the transceiver 1802 (e.g., WLAN transceiver), and/or the TWT communications component 140a (or one of its subcomponents) may be executed to perform the various aspects of the method 1500.

At block 1510, the method 1500 may include identifying, by the STA, a congestion metric. Aspects of identifying or obtaining congestion metrics or related information (e.g., other STAs congestion metrics) are described at least in part with respect to the method 600 above, and in particular with respect to the block 606. Moreover, aspects of the functions associated with the block 1510 may be performed by the identifying component 155 in a congestion component 150 of the TWT communications component 140a in FIG. 18.

In determination block 1520, the method 1500 may include determining whether the congestion metric meets or satisfies a congestion threshold. Aspects of determining whether a congestion metric or congestion level meets a certain threshold are described at least in part with respect to the method 600 above, and in particular with respect to the block 608. Moreover, aspects of the functions associated with the determination block 1520 may be performed by the determining component 160 in the congestion component 150 of the TWT communications component 140a in FIG. 18.

In response to determining that the congestion metric does not meet the congestion threshold, the method 1500 may return to block 1510 and may identify or obtain additional congestion metrics or updated congestion metric information.

However, in response to determining that the congestion metric meets the congestion threshold, the method 1500 may, at block 1530, include transmitting a request to establish TWT communications. Aspects of transmitting a request to, for example, an AP (see e.g., AP1 105-a in FIG. 1 or AP 105 in FIG. 19) to establish TWT communications are described at least in part with respect to the method 600 above, and in particular with respect to the block 612. Moreover, aspects of the functions associated with the block 1530 may be performed by the transmission component 165 in the congestion component 150 of the TWT communications component 140a in FIG. 18, along with one or more of the transceiver 1802 or the RF front end 1888.

In block 1540, the method 1500 may optionally include identifying, by the STA, a second congestion metric. Aspects of identifying or obtaining a second congestion metric or related information (e.g., STA congestion metrics) are described at least in part with respect to the method 600 above, and in particular with respect to the block 614.

In determination block 1570, the method 1500 may optionally include determining whether the second congestion metric is smaller than a second congestion threshold. Aspects of determining whether the second congestion metric is smaller than the second congestion threshold are described at least in part with respect to the method 600 above, and in particular with respect to the block 616.

In response to determining that the second congestion metric is not smaller than the second congestion threshold, the method 1500 may return to block 1540 to identify or obtain additional congestion metrics or updated congestion metric information.

However, in response to determining that the second congestion metric is smaller than the second congestion threshold, the method 1500 may, in block 1580, include transmitting a request to terminate the TWT communications. Aspects of requesting to terminate the TWT communications are described at least in part with respect to the method 600 above. Moreover, aspects of the functions associated with the block 1580 may be performed by a terminating component 180 in a communications scheduling component 145 of the TWT communications component 140a in FIG. 18.

Further, in determination block 1550, the method 1500 may include determining whether a network congestion has increased. Aspects of determining whether a network congestion has increased (or decreased) are described at least in part with respect to the method 600 above, and in particular with respect to block 614 and table 630. Moreover, aspects of the functions associated with the block 1550 may be performed by the determining component 160.

In response to determining that network congestion has not increased, the method 1500 may return to block 1540 to identify or obtain additional congestion metrics or updated congestion information.

However, in response to determining that network congestion has increased, the method 1500 may, in block 1560, include adjusting a duty cycle of the TWT communications. Aspects of adjusting or modifying a duty cycle (e.g., a TWT duty cycle) are described at least in part with respect to the method 600 above, and in particular with respect to block 614 and table 630. Moreover, aspects of the functions associated with the block 1560 may be performed by an adjustment component 170 in the congestion component 150. The adjustment of the duty cycle may include modifying at least one of a service period duration or a service period interval. For example, modifying the service period duration or the service period interval may include transmitting a TWT set-up frame for the TWT communications, requesting a change to at least one of the service period duration or the service period interval. In other aspects, modifying the service period duration or the service period interval may include transmitting a TWT termination request for the TWT communications and establishing a new or second TWT communications based, at least in part, on at least one of a new or second service period duration or a new or second service period interval.

In some aspects, initiating TWT communications may be executed as part of initiating a VoIP call. In such aspects, transmitting the request to initiate TWT communications may include transmitting a TWT set-up frame having a service period wake duration equal to a duration of a VoIP packet interval in the VoIP call.

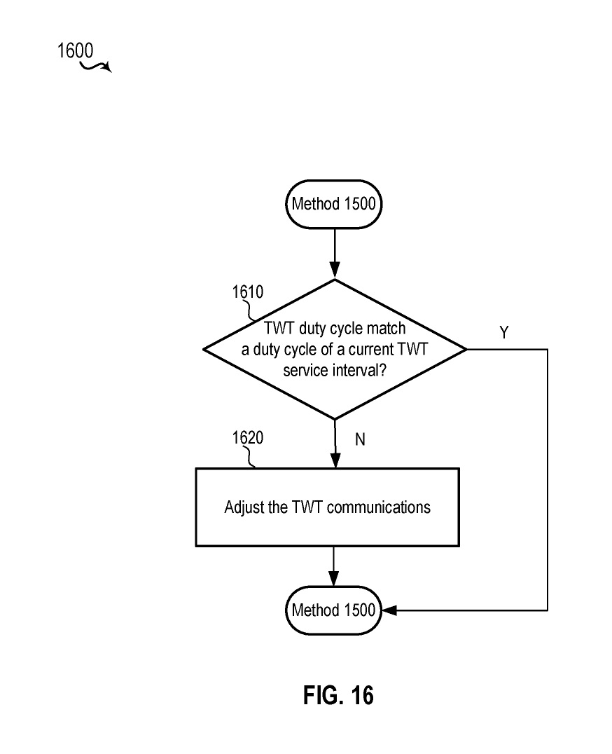

FIG. 16 shows a flow diagram of a method 1600 for adjusting a duty cycle of TWT communications in accordance with various aspects of the present disclosure. The method 1600 may be performed in connection with the method 1500 in FIG. 15 and/or the method 600 in FIG. 6. Accordingly, aspects of the method 1600 described below may be performed by, for example, an STA, such as the STA1 115-a in FIG. 1 or the STA 115 in FIG. 18, where the processor 1812, the modem 1814, the transceiver 1802 (e.g., WLAN transceiver), and/or the TWT communications component 140a (or one of its subcomponents) may be executed to perform the various aspects of the method 1600.

In determination block 1610, the method 1600 may include determining whether a TWT duty cycle matches a duty cycle of a current TWT wake interval of the TWT communications. In an aspect, a table such as the table 630 in FIG. 6 may be used to compare a current duty cycle and a duty cycle needed in accordance with changed conditions.

In response to determining that TWT duty cycle matches the duty cycle of the current TWT wake interval of the TWT communications, the method 1600 may return to method 1500 to continue performing TWT communications scheduling.

However, in response to determining that the TWT duty cycle does not match the duty cycle of the current TWT wake interval of the TWT communications, the method 1600 may, in block 1620, include adjusting, the TWT communication such that the appropriate duty cycle is being used. In an example, the STA may transmit a TWT set-up frame containing modified or updated parameters for the current TWT communications to an AP (e.g., AP1 105-a). This may include modifying a number of TWT sessions of the TWT communications. Some aspects may include transmitting the TWT set-up frame including a flow ID of the TWT communications and one or more TWT parameters, that enable the TWT duty cycle to match the duty cycle of the current TWT wake interval, and storing, in a memory of the STA, the one or more TWT parameters as current TWT parameters in response to receiving, from the AP, a confirmation of the TWT set-up frame acceptance. These one or more TWT parameters may include one or more of a wake duration, a wake interval exponent, a wake interval mantissa, a flow type, or a protection.

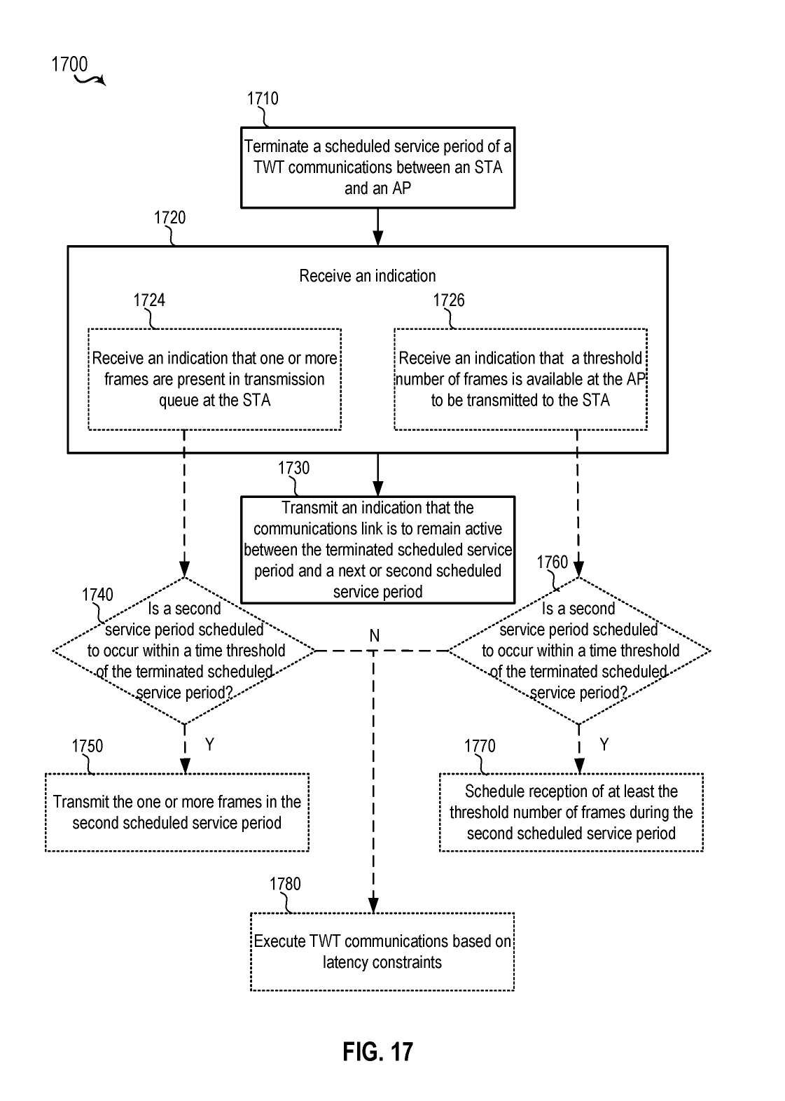

FIG. 17 shows aspect flow diagram of a method 1700 for scheduling TWT communications in accordance with various aspects of the present disclosure. For clarity, the method 1700 is described below with reference to an STA such as the STAs in FIGS. 1 and 18. Aspects of the method 1700 described below may be performed by, for example, an STA, such as the STA1 115-a in FIG. 1 or the STA 115 in FIG. 18, where the processor 1812, the modem 1814, the transceiver 1802 (e.g., WLAN transceiver), and/or the TWT communications component 140a (or one of its subcomponents) may be executed to perform the various aspects of the method 1700.

In block 1710, the method 1700 may include terminating a scheduled service period of a TWT communications between an STA (e.g., STA1 115-a) and an AP (e.g., AP1 105-a). Moreover, aspects of the functions associated with the block 1710 may be performed by the terminating component 180 in the communications scheduling component 145 of the TWT communications component 140a in FIG. 18.

In block 1720, the method 1700 may include receiving at least one indication. In one option, in block 1724, an indication is received that one or more frames are present in a transmission queue at the STA. In another option, in block 1726, an indication is received that a threshold number of frames is available at the AP to be transmitted to the STA. Aspects of the functions associated with the block 1720 (including blocks 1724 and 1726) may be performed by a receiving component 185 in the communications scheduling component 145 of the TWT communications component 140a in FIG. 18.

In block 1730, the method 1700 may include transmitting, by a transceiver of the STA, an indication that a communications link is to remain active between the terminated scheduled service period and a next or second scheduled service period. Aspects of the functions associated with the block 1730 may be performed by a transmission component 190 in the communications scheduling component 145.Further, in response to receiving in block 1724 the indication that one or more frames are present in a transmission queue of the STA, the method 1700 may include in determination block 1740, determining whether a second scheduled service period of the TWT communications is scheduled to occur within a time threshold, wherein the second scheduled service period is scheduled to occur after the terminated scheduled service period. Aspects of the functions associated with the block 1740 may be performed by the determining component 160.

In response to determining that the second scheduled service period is scheduled to occur within the time threshold, the method 1700 may, in block 1750, include transmission of the one or more frames in the transmission queue of the STA during the second scheduled service period. Aspects of the functions associated with the block 1750 may be performed by the transmission component 190.

However, in response to determining that the second scheduled service period is not scheduled to occur within the time threshold, the method 1700 may, in block 1780, execute TWT communications based on latency constraints. Aspects of the functions associated with the block 1780 may be performed by a scheduling component 195 of the communications scheduling component 145.

In some aspects, the scheduling component 195 may determine whether a communications traffic of the STA satisfies a latency constraint. In response to determining that the communications traffic of the STA does not satisfy the latency constraint the STA may transmit, e.g., via the transmission component 190, the one or more frames in the transmission queue of the STA immediately (e.g., without waiting for the next service period). The STA may then place a portion of the transceiver (e.g., the transceiver 1802) in a sleep state.

The scheduling component 195 may be configured to schedule reception of the frames before a scheduled service period. The scheduling component 195 may determine whether a communications traffic of the STA meets a latency constraint. The scheduling component 195 may schedule immediate reception of the frames that are buffered at the AP for transmission to the STA, in response to determining that the STA communications traffic does not meet the latency constraint. The STA may then place a portion of the transceiver in a sleep state. By placing a portion of the transceiver in a sleep state power consumption may be reduced.

Further, in response to receiving, in block 1726, the indication that the threshold number of frames is available at the AP to be transmitted to the STA, the method 1700 may in determination block 1760, determine whether a second scheduled service period of the TWT communications is scheduled to occur within a time threshold, wherein the second scheduled service period is scheduled to occur after the terminated scheduled service period. Aspects of the functions associated with the block 1760 may be performed by the determining component 160.

In response to determining that the second scheduled service period is scheduled to occur within the time threshold, the method 1700 may, in block 1770, schedule reception of at least the threshold number of frames that are available at the AP for transmission to the STA, during the second scheduled service period. Aspects of the functions associated with the block 1770 may be performed by the scheduling component 195.

However, in response to determining that the second scheduled service period is not scheduled to occur within the time threshold, the method 1700 may, in block 1780, execute TWT communications based on latency constraints.

FIG. 18 shows a diagram 1800 that describes hardware components and subcomponents of an STA 115 for implementing the various features described herein in connection with TWT communications, including one or more methods (e.g., methods 1500, 1600, and 1700) described herein in accordance with various aspects of the present disclosure. The STA 115 may be an example of the STAs shown in FIG. 1 and described throughout the present disclosure. As discussed above, when an STA is setting up, modifying, or tearing down TWT communications, the components and subcomponents described herein may be used to at least monitor network congestion, initiate TWT communications based on that network congestion, and schedule communications around and during TWT service periods.

One example of an implementation of STA 115 may include a variety of components, some of which have already been described above, but including components such as one or more processors 1812, the memory 1816, and the transceiver 1802 in communication via one or more buses 1844, which may operate in conjunction with the TWT communications component 140a to enable one or more of the functions described herein, including the functions related to one or more methods of the present disclosure. Further, the one or more processors 1812, the modem 1814, the memory 1816, the transceiver 1802, the RF front end 1888, and the one or more antennas 1865, may be configured to support voice and/or data calls (simultaneously or non-simultaneously) in one or more radio access technologies. For example, the STA 115 may support VoIP calls.

In an aspect, the one or more processors 1812 can include the modem 1814 that uses one or more modem processors. The various functions related to the TWT communications component 140a may be included in modem 1814 and/or processors 1812 and, in an aspect, can be executed by a single processor, while in other aspects, different ones of the functions may be executed by a combination of two or more different processors. For example, in an aspect, the one or more processors 1812 may include any one or any combination of a modem processor, or a baseband processor, or a digital signal processor, or a transmit processor, or a receiver processor, or a transceiver processor associated with transceiver 1802. In other aspects, some of the features of the one or more processors 1812 and/or modem 1814 associated with the TWT communications component 140a may be performed by transceiver 1802.

Also, the memory 1816 may be configured to store data used herein and/or local versions of applications or the TWT communications component 140a and/or one or more of its subcomponents being executed by at least one processor 1812. The memory 1816 can include any type of computer-readable medium usable by a computer or at least one processor 1812, such as random access memory (RAM), read only memory (ROM), tapes, magnetic discs, optical discs, volatile memory, non-volatile memory, and any combination thereof. In an aspect, for example, the memory 1816 may be a non-transitory computer-readable storage medium that stores one or more computer-executable codes defining the TWT communications component 140a and/or one or more of its subcomponents, and/or data associated therewith, when the STA 115 is operating at least one processor 1812 to execute TWT communications component 140a and/or one or more of its subcomponents.

The transceiver 1802 may include at least one receiver 1806 and at least one transmitter 1808. The receiver 1806 may include hardware, firmware, and/or software code executable by a processor for receiving data, the code comprising instructions and being stored in a memory (e.g., computer-readable medium). The receiver 1806 may be, for example, a radio frequency (RF) receiver. In an aspect, receiver 1806 may receive signals transmitted by at an AP or another STA. Additionally, the receiver 1806 may process such received signals, and also may obtain measurements of the signals, such as, but not limited to, Ec/Io, SNR, RSRP, RSSI, etc. The transmitter 1808 may include hardware, firmware, and/or software code executable by a processor for transmitting data, the code comprising instructions and being stored in a memory (e.g., computer-readable medium). A suitable example of the transceiver 1802 may including, but is not limited to, an RF transmitter.

Moreover, in an aspect, the STA 115 may include the RF front end 1888, which may operate in communication with the one or more antennas 1865 and the transceiver 1802 for receiving and transmitting radio transmissions. The RF front end 1888 may be connected to the one or more antennas 1865 and can include one or more low-noise amplifiers (LNAs) 1890, one or more switches 1892, one or more power amplifiers (PAs) 1898, and one or more filters 1896 for transmitting and receiving RF signals.

In an aspect, LNA 1890 can amplify a received signal at a desired output level. In an aspect, each LNA 1890 may have a specified minimum and maximum gain values. In an aspect, the RF front end 688 may use the one or more switches 1892 to select a particular LNA 1890 and its specified gain value based on a desired gain value for a particular application.

Further, for example, one or more PA(s) 1898 may be used by the RF front end 1888 to amplify a signal for an RF output at a desired output power level. In an aspect, each PA 1898 may have specified minimum and maximum gain values. In an aspect, the RF front end 1888 may use the one or more switches 1892 to select a particular PA 1898 and its specified gain value based on a desired gain value for a particular application.

Also, for example, the one or more filters 1896 can be used by the RF front end 1888 to filter a received signal to obtain an input RF signal. Similarly, in an aspect, for example, a respective filter 1896 can be used to filter an output from a respective PA 1898 to produce an output signal for transmission. In an aspect, each filter 1896 can be connected to a specific LNA 1890 and/or PA 1898. In an aspect, the RF front end 1888 can use the one or more switches 1892 to select a transmit or receive path using a specified filter 1896, LNA 1890, and/or PA 1898, based on a configuration as specified by transceiver 1802 and/or processor 1812.

As such, transceiver 1802 may be configured to transmit and receive wireless signals through the one or more antennas 1865 via the RF front end 1888. In an aspect, the transceiver 1802 may be tuned to operate at specified frequencies such that STA 115 can communicate with, for example, other STAs or with an AP. In an aspect, for example, the modem 1814 can configure the transceiver 1802 to operate at a specified frequency and power level based on the configuration of the STA 115 and the communication protocol used by the modem 1814.

In an aspect, the modem 1814 can be a multiband-multimode modem, which can process digital data and communicate with the transceiver 1802 such that the digital data is sent and received using the transceiver 1802. In an aspect, the modem 1814 can be multiband and be configured to support multiple frequency bands for a specific communications protocol. In an aspect, the modem 1814 can be multimode and be configured to support multiple operating networks and communications protocols. In an aspect, the modem 1814 can control one or more components of the STA 115 (e.g., the RF front end 1888, the transceiver 1802) to enable transmission and/or reception of signals based on a specified modem configuration. In an aspect, the modem configuration can be based on the mode of the modem and the frequency band in use.

As described above, the TWT communications component 140a may include the congestion component 150. The congestion component 150 may have subcomponents configured to communicate with and support the various hardware components of the STA 115. The identifying component 155 may monitor channel congestion and/or network congestion to identify or obtain congestion metrics. The determining component 160 may operate in conjunction with the processors 1812 and/or the modem 1814 to determine whether the congestion metric meets a congestion threshold. The transmission component 165 may be implemented by or may be a subcomponent of the transceiver 1802 and may transmit a request to establish TWT communications in response to determining that the congestion metric meets the congestion threshold. The adjustment component 170 may be implemented by the processor 1812, the modem 1814, and/or the transceiver 1802 and may enable the STA 115 to modify or otherwise adjust set-up parameters of the TWT communications such as a service period, a service interval, a wake duration, and other parameters.

Also as described above, the TWT communications component 140a may also include the communications scheduling component 145, which may operate in conjunction with the transceiver 1802, the processors 1812, the modem 1814, and other components to handle scheduling of TWT communications. The communications scheduling component 145 may include the terminating component 180 that terminates a scheduled service period of the TWT communications. The receiving component 185 may be implemented by or may be a subcomponent of the transceiver 1802 and may receive and process different types of indications, including indications that there are frames queued for transmission at the STA 115 and indications that there are frames available at an AP for transmission to the STA 115. Further, the transmission component 190 may be implemented by or may be a subcomponent of transceiver 1802 and may transmit to an AP, an indication that a communications link is to remain active between a terminated scheduled service period and a next or second scheduled service period. The scheduling component 195 may prepare frames in a transmission queue for transmission during a TWT service period or in between TWT service periods.

The TWT communications component 140a may also include transmission queues 171, as well as an uplink/downlink (UL/DL) ping component 172 for handling aspects of the uplink ping and downlink ping operations described in connection with FIGS. 11 and 12. The

TWT communications component 140a may also include a large traffic component 173 for handling aspects of large traffic operations as described herein in connection with FIG. 13. Moreover, the TWT communications component 140a may also include an off-channel component 174 for handling aspects of off-channel operations as described herein in connection with FIG. 14. The components 171, 172, 173, and 174 may operate in conjunction with one or both of the congestion component 150 or the communications scheduling component 145.

FIG. 19 shows a diagram 1900 that describes hardware components and subcomponents of an AP 105 as described herein in accordance with various aspects of the present disclosure. The AP 105 may be an example of the APs shown in FIG. 1 and described throughout the present disclosure.

One example of an implementation of the AP 105 may include a variety of components, some of which have already been described above, but including components such as one or more processors 1912, a memory 1916, and a transceiver 1902 in communication via one or more buses 1944, which may operate in conjunction with the TWT communications component 140b to enable one or more of the functions described in connection with AP operations of the present disclosure. Further, the one or more processors 1912, a modem 1914, the memory 1916, the transceiver 1902, an RF front end 1988, and one or more antennas 1965, may be configured to support voice and/or data calls (simultaneously or non-simultaneously) in one or more radio access technologies. For example, the AP 105 may support VoIP calls.

In an aspect, the one or more processors 1912 can include the modem 1914 that uses one or more modem processors. The various functions related to the TWT communications component 140b may be included in the modem 1914 and/or the processors 1912 and, in an aspect, can be executed by a single processor, while in other aspects, different ones of the functions may be executed by a combination of two or more different processors. For example, in an aspect, the one or more processors 1912 may include any one or any combination of a modem processor, or a baseband processor, or a digital signal processor, or a transmit processor, or a receiver processor, or a transceiver processor associated with the transceiver 1902. In other aspects, some of the features of the one or more processors 1912 and/or the modem 1914 associated with the TWT communications component 140b may be performed by the transceiver 1902.

Also, the memory 1916 may be configured to store data used herein and/or local versions of applications or the TWT communications component 140b and/or one or more of its subcomponents being executed by at least one processor 1912. The memory 1916 can include any type of computer-readable medium usable by a computer or at least one processor 1912, such as random access memory (RAM), read only memory (ROM), tapes, magnetic discs, optical discs, volatile memory, non-volatile memory, and any combination thereof. In an aspect, for example, the memory 1916 may be a non-transitory computer-readable storage medium that stores one or more computer-executable codes defining the TWT communications component 140b and/or one or more of its subcomponents, and/or data associated therewith, when the AP 105 is operating at least one processor 1912 to execute the TWT communications component 140b and/or one or more of its subcomponents.

The transceiver 1902 may include at least one receiver 1906 and at least one transmitter 1908. The receiver 1906 may include hardware, firmware, and/or software code executable by a processor for receiving data, the code comprising instructions and being stored in a memory (e.g., computer-readable medium). The receiver 1906 may be, for example, a radio frequency (RF) receiver. In an aspect, the receiver 1906 may receive signals transmitted by an STA or another AP. Additionally, the receiver 1906 may process such received signals, and also may obtain measurements of the signals, such as, but not limited to, Ec/Io, SNR, RSRP, RSSI, etc. The transmitter 1908 may include hardware, firmware, and/or software code executable by a processor for transmitting data, the code comprising instructions and being stored in a memory (e.g., computer-readable medium). For example, when the AP 105 is participating in TWT communications, the AP may transmit and receive frames. A suitable example of transceiver 1902 may including, but is not limited to, an RF transmitter.

Moreover, in an aspect, the AP 105 may include the RF front end 1988, which may operate in communication with the one or more antennas 1965 and the transceiver 1902 for receiving and transmitting radio transmissions, for example, wireless communications. The RF front end 1988 may be connected to the one or more antennas 1965 and can include one or more low-noise amplifiers (LNAs) 1990, one or more switches 1992, one or more power amplifiers (PAs) 1998, and one or more filters 1996 for transmitting and receiving RF signals.

In an aspect, the LNA 1990 can amplify a received signal at a desired output level. In an aspect, each LNA 1990 may have a specified minimum and maximum gain values. In an aspect, the RF front end 688 may use the one or more switches 1992 to select a particular LNA 1990 and its specified gain value based on a desired gain value for a particular application.

Further, for example, the one or more PA(s) 1998 may be used by the RF front end 1988 to amplify a signal for an RF output at a desired output power level. In an aspect, each PA 1998 may have specified minimum and maximum gain values. In an aspect, the RF front end 1988 may use the one or more switches 1992 to select a particular PA 1998 and its specified gain value based on a desired gain value for a particular application.

Also, for example, the one or more filters 1996 can be used by the RF front end 1988 to filter a received signal to obtain an input RF signal. Similarly, in an aspect, for example, a respective filter 1996 can be used to filter an output from a respective PA 1998 to produce an output signal for transmission. In an aspect, each filter 1996 can be connected to a specific LNA 1990 and/or PA 1998. In an aspect, the RF front end 1988 can use the one or more switches 1992 to select a transmit or receive path using a specified filter 1996, LNA 1990, and/or PA 1998, based on a configuration as specified by the transceiver 1902 and/or the processor 1912.

As such, the transceiver 1902 may be configured to transmit and receive wireless signals through the one or more antennas 1965 via the RF front end 1988. In an aspect, the transceiver 1902 may be tuned to operate at specified frequencies such that the AP 105 can communicate with, for example, one or more STAs 115 or another AP 105. In an aspect, for example, the modem 1914 can configure the transceiver 1902 to operate at a specified frequency and power level based on the configuration of the AP 105 and the communication protocol used by the modem 1914.

In an aspect, the modem 1914 can be a multiband-multimode modem, which can process digital data and communicate with the transceiver 1902 such that the digital data is sent and received using the transceiver 1902. In an aspect, the modem 1914 can be multiband and be configured to support multiple frequency bands for a specific communications protocol. In an aspect, the modem 1914 can be multimode and be configured to support multiple operating networks and communications protocols. In an aspect, the modem 1914 can control one or more components of the AP 105 (e.g., the RF front end 1988, the transceiver 1902) to enable transmission and/or reception of signals based on a specified modem configuration. In an aspect, the modem configuration can be based on the mode of the modem and the frequency band in use.

The TWT communications component 140b may perform functions from the perspective of the AP that complement the functions described herein in connection with the STAs for TWT communications. The TWT communications component 140b may include a TWT communications scheduling component 181 that coordinates the scheduling of TWT communications with one or more STAs. The TWT communications component 140b may also include a TWT parameters 182 for maintaining, updating, revising, accepting, and/or storing TWT parameters. The TWT communications component 140b may also include a requests handling component 183 that receives, processes, and responds to different requests by STAs in connection with TWT communications. The TWT communications component 140b may also include an UL/DL ping component 184 that performs AP-side functions associated with uplink ping and downlink ping operations described in connection with FIGS. 11 and 12. The TWT communications component 140b may also include a QoS null frame handling component 191 that receives, processes, and responds to QoS null frames (e.g., QoS null frames with PM 0, QoS null frames with PM 1) from one or more STAs. The TWT communications component 140b may also include an indications component 192 that generates and transmits (e.g., via the transceiver 1902 and/or the RF front end 1988) one or more indications to an STA, including indications (e.g., beacons) that convey the presence of one or more frames in transmission buffers 193 for transmission to the STA.

Each of the various subcomponents of the TWT communications component 140b may operate independently or may operate in conjunction with one or more other subcomponents of the TWT communications component 140b.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of scheduling communications between a wireless station and an access point, comprising:
terminating a scheduled service period of a target wake time (TWT) communications between the wireless station and the access point;
receiving, by the wireless station, at least one of an indication that a threshold number of frames is available to be transmitted to the wireless station from the access point or an indication that one or more frames are present in a transmission queue at the wireless station; and
transmitting, by a transceiver of the wireless station, to the access point, an indication that a communications link is to remain active between the terminated scheduled service period and a second scheduled service period.

2. The method of claim 1, wherein the indication that the communications link is to remain active is a quality of service null frame or a power management bit set to zero.

3. The method of claim 1, further comprising in response to receiving, by the wireless station, the indication that the one or more frames are present in the transmission queue of the wireless station:
determining whether the second scheduled service period is scheduled to occur within a time threshold, wherein the second scheduled service period is scheduled to occur after the terminated scheduled service period; and
transmitting the one or more frames in the transmission queue during the second scheduled service period, in response to determining that the second scheduled service period is scheduled to occur within the time threshold.

4. The method of claim 3, further comprising in response to determining that the second scheduled service period is not scheduled to occur within the time threshold:
determining whether a communications traffic of the wireless station meets a latency constraint;
transmitting the one or more frames in the transmission queue immediately, in response to determining that the communications traffic does not meet the latency constraint; and
placing a portion of the transceiver in a sleep state.

5. The method of claim 1, further comprising in response to receiving, by the wireless station, the indication that the threshold number of frames is available to be transmitted to the wireless station from the access point:
determining whether the second scheduled service period is scheduled to occur within a time threshold, wherein the second scheduled service period is scheduled to occur after the terminated scheduled service period; and
scheduling reception of at least the threshold number of frames during the second scheduled service period, in response to determining that the second scheduled service period is scheduled to occur within the time threshold.

6. The method of claim 5, further comprising in response to determining that the second scheduled service period is not scheduled to occur within the time threshold:
determining whether a communications traffic of the wireless station meets a latency constraint;
scheduling immediate reception of at least the threshold number of frames, in response to determining that the communications traffic does not meet the latency constraint; and
placing a portion of the transceiver in a sleep state.

7. The method of claim 1, wherein the TWT communications is established during initiation of a voice over Internet Protocol (VoIP) call.

8. A wireless station for scheduling communications with an access point, comprising:
a transceiver;
a memory; and
a processor coupled to the memory and the transceiver, and configured to:
terminate a scheduled service period of a target wake time (TWT) communications;
receive at least one of an indication that a threshold number of frames is available to be transmitted to the wireless station from the access point or an indication that one or more frames are present in a transmission queue at the wireless station; and
transmit to the access point, an indication that a communications link is to remain active between the terminated scheduled service period and a second scheduled service period.

9. The wireless station of claim 8, wherein the indication that the communications link is to remain active is a quality of service null frame or a power management bit set to zero.

10. The wireless station of claim 8, wherein in response to receiving the indication that the one or more frames are present in the transmission queue of the wireless station, the processor is further configured to:
determine whether the second scheduled service period is scheduled to occur within a time threshold, wherein the second scheduled service period is scheduled to occur after the terminated scheduled service period; and
transmit the one or more frames in the transmission queue during the second scheduled service period, in response to determining that the second scheduled service period is scheduled to occur within the time threshold.

11. The wireless station of claim 10, wherein in response to determining that the second scheduled service period is not scheduled to occur within the time threshold, the processor is further configured to:
determine whether a communications traffic of the wireless station meets a latency constraint;
transmit the one or more frames in the transmission queue immediately, in response to determining that the communications traffic does not meet the latency constraint; and
place a portion of the transceiver in a sleep state.

12. The wireless station of claim 8, wherein in response to receiving, by the wireless station, the indication that the threshold number of frames is available to be transmitted to the wireless station from the access point, the processor is further configured to::
determine whether the second scheduled service period is scheduled to occur within a time threshold, wherein the second scheduled service period is scheduled to occur after the terminated scheduled service period; and
schedule reception of at least the threshold number of frames during the second scheduled service period, in response to determining that the second scheduled service period is scheduled to occur within the time threshold.

13. The wireless station of claim 12, wherein in response to determining that the second scheduled service period is not scheduled to occur within the time threshold, the processor is further configured to:
determine whether a communications traffic of the wireless station meets a latency constraint;
schedule immediate reception of at least the threshold number of frames, in response to determining that the communications traffic does not meet the latency constraint; and
place a portion of the transceiver in a sleep state.

14. The wireless station of claim 8, wherein the TWT communications is established during initiation of a voice over Internet Protocol (VoIP) call.

15. A wireless station for scheduling communications with an access point, comprising:
means for terminating a scheduled service period of a target wake time (TWT) communications scheduling;
means for receiving at least one of an indication that a threshold number of frames is available for transmission to the wireless station from the access point and an indication that one or more frames are present in a transmission queue at the wireless station; and
means for transmitting to the access point, an indication that a communications link is to remain active between the terminated scheduled service period and a second scheduled service period.

16. The wireless station of claim 15, wherein the indication that the communications link is to remain active is a quality of service null frame or a power management bit set to zero.

17. The wireless station of claim 15, further comprising:
means for performing operations in response to receiving, by the wireless station, the indication that the one or more frames are present in the transmission queue of the wireless station, the means for performing the operations comprising:
means for determining whether the second scheduled service period is scheduled to occur within a time threshold, wherein the second scheduled service period is scheduled to occur after the terminated scheduled service period; and
means for transmitting the one or more frames in the transmission queue during the second scheduled service period, in response to determining that the second scheduled service period is scheduled to occur within the time threshold.

18. The wireless station of claim 17, further comprising:
means for performing operations in response to determining that the second scheduled service period is not scheduled to occur within the time threshold, the means for performing the operations comprising:
means for determining whether a communications traffic of the wireless station meets a latency constraint; and
means for transmitting the one or more frames in the transmission queue immediately, in response to determining that the communications traffic does not meet the latency constraint; and
means for placing a portion of the transceiver in a sleep state.

19. The wireless station of claim 15, further comprising:
means for performing operations in response to receiving, by the wireless station, the indication that the threshold number of frames is available for transmission to the wireless station from the access point, the means for performing the operations comprising:
means for determining whether the second scheduled service period is scheduled to occur within a time threshold, wherein the second scheduled service period is scheduled to occur after the terminated service period; and
means for scheduling reception of at least the threshold number of frames during the second scheduled service period, in response to determining that the second scheduled service period is scheduled to occur within the time threshold.

20. The wireless station of claim 19, further comprising:
means for performing operations in response to determining that the second scheduled service period is not scheduled to occur within the time threshold, the means for performing the operations comprising:
means for determining whether a communications traffic of the wireless station meets a latency constraint; and
means for scheduling immediate reception of at least the threshold number of frames, in response to determining that the communications traffic does not meet the latency constraint; and
means for placing a portion of the transceiver in a sleep state.

21. The wireless station of claim 15, wherein the TWT communications is established during initiation of a voice over Internet Protocol (VoIP) call.

22. A computer-readable medium having stored instructions to cause a processor to schedule communications between a wireless station and an access point, comprising:
code for terminating a scheduled service period of a target wake time (TWT) communications scheduling;
code for receiving at least one of an indication that a threshold number of frames is available for transmission to the wireless station from the access point or an indication that one or more frames are present in a transmission queue at the wireless station; and
code for transmitting to the access point, an indication that a communications link is to remain active between the terminated service period and a second scheduled service period.

23. The computer-readable medium of claim 22, wherein the indication that the communications link is to remain active is a quality of service null frame or a power management bit set to zero.

24. The computer-readable medium of claim 22, further comprising:
code for performing operations in response to receiving, by the wireless station, the indication that the one or more frames are present in the transmission queue of the wireless station, the code for performing the operations comprising:
code for determining whether the second scheduled service period is scheduled to occur within a time threshold, wherein the second scheduled service period is scheduled to occur after the terminated service period; and
code for transmitting the one or more frames in the transmission queue of the wireless station during the second scheduled service period, in response to determining that the second scheduled service period is scheduled to occur within the time threshold.

25. The computer-readable medium of claim 24, further comprising:
code for performing operations in response to determining that the second scheduled service period is not scheduled to occur within the time threshold, the code for performing the operations comprising:
code for determining whether a communications traffic meets a latency constraint; and
code for transmitting the one or more frames in the transmission queue immediately, in response to determining that the communications traffic does not meet the latency constraint; and
code for placing a portion of the transceiver in a sleep state.

26. The computer-readable medium of claim 22, further comprising:
code for performing operations in response to receiving, by the wireless station, the indication that the threshold number of frames is available for transmission to the wireless station from the access point, the code for performing the operations comprising:
code for determining whether the second scheduled service period is scheduled to occur within a time threshold, wherein the second scheduled service period is scheduled to occur after the terminated service period; and
code for scheduling reception of at least the threshold number of frames during the second scheduled service period, in response to determining that the second scheduled service period is scheduled to occur within the time threshold.

27. The computer-readable medium of claim 26, further comprising:
code for performing operations in response to determining that the second scheduled service period is not scheduled to occur within the time threshold, the code for performing the operations comprising:
code for determining whether a communications traffic of the wireless station meets a latency constraint; and
code for scheduling immediate reception of at least the threshold number of frames, in response to determining that the communications traffic does not meet the latency constraint; and
code for placing a portion of the transceiver in a sleep state.

28. The computer-readable medium of claim 22, wherein the TWT communications scheduling is established during initiation of a voice over Internet Protocol (VoIP) call.
